(19) United States
(12) Patent Application Publication
(10) Pub. No.: US 2024/0151927 A1
(43) Pub. Date: May 9, 2024

(54) FIBER OPTIC CLOSURE ORGANIZER WITH VERSATILE BASKET OPTICAL FIBER RETAINER AND OTHER ORGANIZER IMPROVEMENTS

(71) Applicant: CommScope Technologies LLC, Hickory, NC (US)

(72) Inventors: Bart Mattie CLAESSENS, Hasselt (BE); Geert VAN GENECHTEN, Vorselaar (BE)

(73) Assignee: CommScope Technologies LLC, Hickory, NC (US)

(21) Appl. No.: 18/549,720

(22) PCT Filed: Mar. 11, 2022
(86) PCT No.: PCT/US2022/019909

§ 371 Date: Sep. 8, 2023

Related U.S. Application Data
(60) Provisional application No. 63/160,142, filed on Mar. 12, 2021.
(60) Provisional application No. 63/299,602, filed on Jan. 14, 2022.
(60) Provisional application No. 63/309,066, filed on Feb. 11, 2022.

(51) Int. Cl. G02B 6/44

(52) U.S. Cl. CPC G02B 6/4455; G02B 6/4442; G02B 6/44526

(57) ABSTRACT

Fiber management organizer assemblies of telecommunications closures. The assemblies include a basket for holding portions of optical fibers and a fiber management tray support structure that pivotally supports fiber management trays. A fiber retainer can be selectively mounted at any of a plurality of mounting locations defined by the tray support structure or another structure based on specific fiber management requirements for a given organizer.

### CROSS-REFERENCE TO RELATED APPLICATIONS

This application is being filed on Mar. 11, 2022 as a PCT International Patent Application and claims the benefit of U.S. Patent Application Ser. No. 63/160,142, filed on Mar. 12, 2021, claims the benefit of U.S. Patent Application Ser. No. 63/299,602, filed on Jan. 14, 2022 and claims the benefit of U.S. Patent Application Ser. No. 63/309,066, filed on Feb. 11, 2022, the disclosures of which are incorporated herein by reference in their entireties.

### TECHNICAL FIELD

The present disclosure relates to telecommunications enclosures, and more particularly to features of fiber organizer assemblies housed in telecommunications closures.

### BACKGROUND

Telecommunications systems typically employ a network of telecommunications cables capable of transmitting large volumes of data and voice signals over relatively long distances. Telecommunications cables can include fiber optic cables, electrical cables, or combinations of electrical and fiber optic cables. A typical telecommunications network also includes a plurality of telecommunications enclosures integrated throughout the network of telecommunications cables. The telecommunications enclosures (or “closures”) are adapted to house and protect telecommunications components such as splices, termination panels, power splitters, wave division multiplexers, fiber management trays, cable organizing, fiber routing components, etc.

Typically, telecommunications closures house a fiber organizing assembly having equipment for organizing fibers, storing fibers, and optically connecting provider side fibers to subscriber side fibers. A given closure can accommodate different types of optical connections between fibers, such as connector to connector connections and fiber splices.

### SUMMARY

In general terms, the present disclosure is directed to improvements in fiber management equipment of fiber management organizers of telecommunications closures.

In one aspect, the present disclosure is directed to an improved telecommunications closure.

In another aspect, the present disclosure is directed to an improved fiber management organizer of a telecommunications closure.

In another aspect, the present disclosure is directed to fiber management organizers having features that provide customizable retention of fibers in fiber storage baskets of the organizers.

In another aspect, the present disclosure is directed to a fiber retainer configured to customizably mount to a support structure configured to pivotally support fiber management trays.

In another aspect, the present disclosure is directed to a fiber retainer configured to couple with features of a fiber management tray support structure that are also configured to pivotally couple a fiber management tray.

In another aspect, the present disclosure is directed to a fiber management tray and a fiber retainer both having features configured to couple to the same coupling feature of a tray support structure.

In another aspect, the present disclosure is directed to fiber management organizers having relative dimensions configured to maximize usable space within a scalable closure.

In another aspect, the present disclosure is directed to a fiber loop storage basket of a fiber management organizer having relative dimensions configured to maximize usable space within a sealable closure.

According to certain aspects of the present disclosure, an optical fiber management organizer for a telecommunications closure, includes: a basket, including a support surface and walls extending from the support surface, the support surface and the walls defining a basket volume for storing loops of optical fibers; a tray support structure, the tray support structure defining mounting locations for pivotally mounting optical fiber management trays; and a fiber retainer, the fiber retainer including a retaining portion having a retaining body and a mounting portion having a mounting body, the mounting body being configured to lockingly engage the support structure at any of the mounting locations such that the retaining portion is positioned to retain the loops of optical fibers between a retaining surface of the retaining portion and the support surface of the basket.

According to further aspects of the present disclosure, a fiber retainer includes: a retaining portion having a retaining body and a mounting portion having a mounting body, the mounting body being configured to lockingly engage an optical fiber management tray support structure at any of a plurality of mounting locations defined by the support structure each of which is also configured to pivotally mount an optical fiber management tray.

According to further aspects of the present disclosure, a method of using a customizable fiber retainer to retain optical fibers positioned in a basket of an optical fiber organizer of a fiber optic closure, includes: a) arranging the optical fibers in the basket; b) selecting one of a plurality of mounting locations on a tray support structure of the organizer, the tray support structure being configured to pivotally mount fiber management trays; and c) subsequent to b) lockingly mounting the fiber retainer to the tray support structure at the selected mounting location.

According to further aspects of the present disclosure, an optical fiber management organizer for a telecommunications closure, includes: a basket, including a support surface and a wall extending from the support surface, the support surface and the wall defining a basket volume for storing loops of optical fibers, a dimension of the wall perpendicular to the support surface defining a height dimension of the basket volume; and a fiber retainer, the fiber retainer including a retaining portion having a retaining body and a mounting portion having a mounting body, the mounting body being configured to be locked at each of a plurality of mounting locations, each of the mounting locations being at a different height relative to the height dimension of the basket volume.

According to further aspects of the present disclosure, a method of using a customizable fiber retainer to retain optical fibers positioned in a basket of an optical fiber organizer of a fiber optic closure, the basket including a support surface and a wall extending from the support surface, the support surface and the wall defining a basket volume, a dimension of the wall perpendicular to the support surface defining a height dimension of the basket volume, includes: a) arranging the optical fibers in the basket; b) selecting one of a plurality of mounting locations to provide a selected mounting location, each of the mounting locations being at a different height along the height dimension of the basket volume, and c) subsequent to b) lockingly mounting the fiber retainer at the selected mounting location.

According to further aspects of the present disclosure, an optical fiber management organizer for a telecommunications closure, includes: a basket, including a support surface and a wall extending from the support surface, the support surface and the wall defining a basket volume for storing loops of optical fibers, a dimension of the wall perpendicular to the support surface defining a height dimension of the basket volume, wherein the height dimension decreases along a longitudinal dimension of the basket.

According to further aspects of the present disclosure, an optical fiber management organizer for a telecommunications closure, includes: a piece; and a stack of fiber management trays pivotally mounted relative to the piece and that tapers towards a longitudinal axis defined by the organizer.

A variety of additional inventive aspects will be set forth in the description that follows. The inventive aspects can relate to individual features and to combinations of features. It is to be understood that both the foregoing general description and the following detailed description are exemplary and explanatory only and are not restrictive of the broad inventive concepts upon which the embodiments disclosed herein are based.

### BRIEF DESCRIPTION OF THE DRAWINGS

The following drawings are illustrative of particular embodiments of the present disclosure and therefore do not limit the scope of the present disclosure. The drawings are not to scale and are intended for use in conjunction with the explanations in the following detailed description. Embodiments of the present disclosure will hereinafter be described in conjunction with the appended drawings, wherein like numerals denote like elements.

FIG. 1 is a perspective view of a telecommunications closure in accordance with the present disclosure, the closure being in a closed configuration.

FIG. 2 is a perspective view of the housing pieces of the closure of FIG. 1.

FIG. 3 is a perspective view of an optical fiber management organizer according to the present disclosure.

FIG. 4 is a further perspective view of the organizer of FIG. 3.

FIG. 5 is a side view of the organizer of FIG. 3.

FIG. 6 is a perspective view of a portion of the organizer of FIG. 3.

FIG. 7 is a perspective view of a further portion of the organizer of FIG. 3.

FIG. 8 is an enlarged view of the called-portion A of FIG. 7.

FIG. 9 is a further perspective view of the portion of the organizer of FIG. 7.

FIG. 10 is an enlarged view of the called-out portion B of FIG. 9.

FIG. 11 is a top view of the portion of the organizer of FIG. 7.

FIG. 12 is a perspective cross-sectional view of the portion of the organizer of FIG. 7 along the line C-C in FIG. 11.

FIG. 13 is an enlarged view of the called-out portion D of FIG. 12.

FIG. 14 is a partially exploded view of the portion of the organizer of FIG. 7.

FIG. 15 is a further partially exploded view of the portion of the organizer of FIG. 7.

FIG. 16 is a perspective view of the customizable fiber retainer of the organizer of FIG. 1.

FIG. 17 is a further perspective view of the customizable fiber retainer of FIG. 16.

FIG. 18 is a top view of the customizable fiber retainer of FIG. 16.

FIG. 19 is a bottom view of the customizable fiber retainer of FIG. 16.

FIG. 20 is a perspective view of a subassembly of an optical fiber management organizer, including a further example of a customizable fiber retainer according to the present disclosure.

FIG. 21 is a side view of the subassembly of FIG. 20.

FIG. 22 is a perspective view of the customizable fiber retainer of FIG. 20.

FIG. 23 is a further perspective view of the customizable fiber retainer of FIG. 20.

FIG. 24 is a top view of a portion of an organizer including the subassembly of FIG. 20.

FIG. 25 is a perspective cross-sectional view of the portion of the organizer of FIG. 24 along the line E-E in FIG. 24.

FIG. 26 is an enlarged view of the called-out portion F of FIG. 25.

FIG. 27 illustrates a portion of an optical fiber management organizer including a fiber storage basket storing fibers and the customizable fiber retainer of FIG. 16.

FIG. 28 is a perspective view of a further example telecommunications closure in accordance with the present disclosure, the closure being in a closed configuration.

FIG. 29 is a further perspective view of the closure of FIG. 28, the closure being in a closed configuration.

FIG. 30 is a perspective view of a further example optical fiber management organizer according to the present disclosure and that can be housed in the closure of FIG. 28.

FIG. 31 is a further perspective view of the organizer of FIG. 30.

FIG. 32 is a further perspective view of the organizer of FIG. 30.

FIG. 33 is a further perspective view of the organizer of FIG. 30.

FIG. 34 is a perspective view of a base to which the organizer of FIG. 30 can be snap-connected.

FIG. 35 is a further perspective view of the base of FIG. 34.

FIG. 36 is a partial exploded view of the organizer of FIG. 30.

FIG. 37 is a further partial exploded of the organizer of FIG. 30.

FIG. 38 is an enlarged view of a portion of the organizer of FIG. 30 and having adjustable basket optical fiber retainers at first positions.

FIG. 39 is an enlarged view of a further portion of the organizer of FIG. 30 and having adjustable basket optical fiber retainers at the first positions.

FIG. 40 is an enlarged view of the portion of the organizer of FIG. 38 and having the adjustable basket optical fiber retainers at second positions.

FIG. 41 is an enlarged view of a further portion of the organizer of FIG. 30 and having the adjustable basket optical fiber retainers at the second position.

FIG. 42 is a perspective view of one of the adjustable optical fiber retainers of the organizer of FIG. 30.

FIG. 43 is a further perspective view of the adjustable optical fiber retainer of FIG. 42.

FIG. 44 is a side view of one of the pieces of the organizer of FIG. 30.

FIG. 45 is a planar view of the organizer piece depicted in FIG. 44.

FIG. 46 is a perspective view of an alternative embodiment of the organizer piece of FIG. 44.

FIG. 47 is a further perspective view of the embodiment of the organizer piece of FIG. 46.

FIG. 48 is a side of the organizer piece of FIG. 46.

FIG. 49 is a planar view of the organizer piece of FIG. 46.

FIG. 50 is a side view of another example of an organizer that can be positioned in the closure of FIG. 28, and that includes the organizer piece of FIG. 46.

### DETAILED DESCRIPTION

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

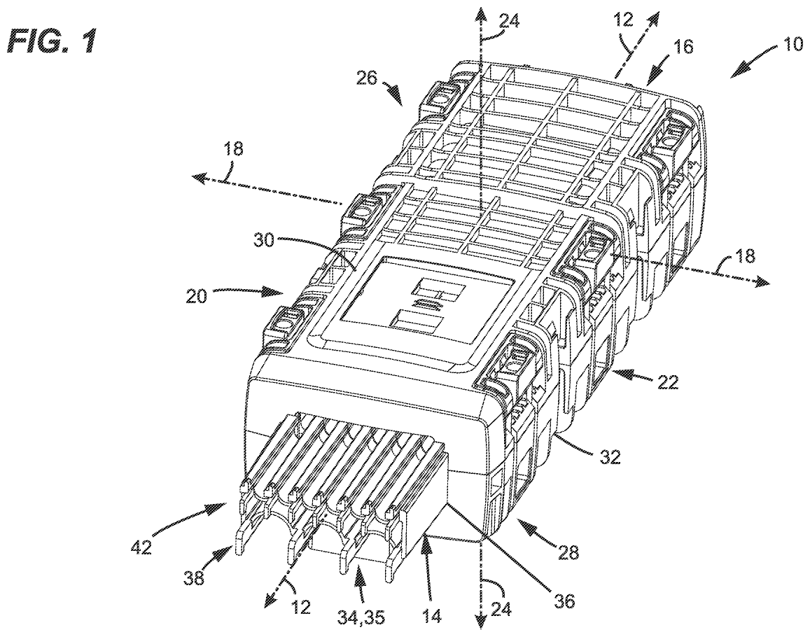

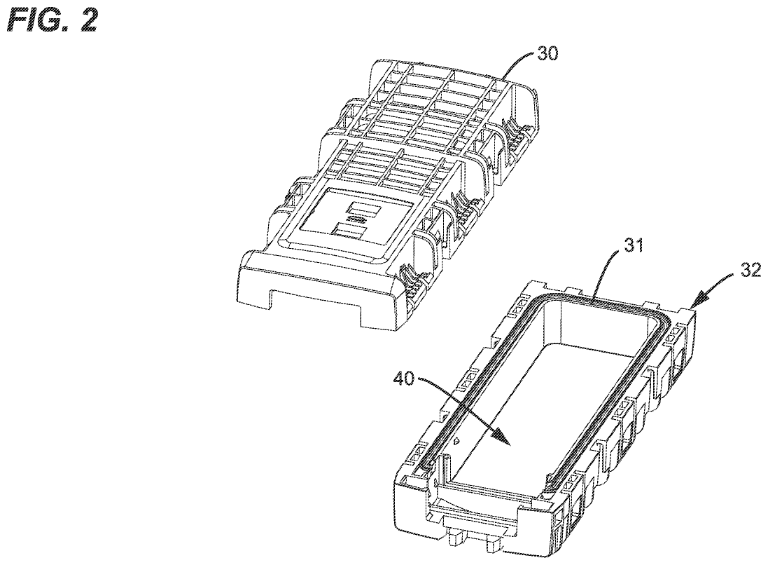

Referring to FIGS. 1 and 2, a telecommunications closure 10 extends along a longitudinal axis 12 between a proximal end 14 and a distal end 16. The closure 10 extends along a transverse axis 18 between a first side 20 and a second side 22. The closure 10 extends along a vertical axis 24 between a top 26 and a bottom 28. The axes 12, 18 and 24 are mutually perpendicular, with the axes 12 and 18 defining a horizontal plane.

As used herein, terms such as proximal, distal, top, bottom, upper, lower, vertical, horizontal and so forth will be used with reference to the axes 12, 18, and 24 of FIG. 1 and in relating the positions of one component to another with respect to the full closure assembly of FIG. 1. These relative terms are for ease of description only, and do not limit how the closure 10 or any individual component or combination of components, may be oriented in practice.

The closure 10 includes a first upper housing piece 30 and a second lower housing piece 32 that cooperate (e.g., with hinges, clamps, etc.) to form a sealable and re-enterable closure volume 40. A perimeter seal element 31 forms a seal about three sides of the closure volume 40 when the closure 10 is in a sealed and closed configuration.

The closure volume 40 is configured to house a fiber management organizer 34. Cables enter the closure volume 40 via the opening 36 and sealed cable ports defined by the internal portion of the cable organizer 34.

The cable organizer 34 is configured to accommodate relatively thick cables (such as feeder cables and branch cables) entering the closure 10 via a lower region 38 of the cable organizer 34, and relatively thin cables (such as drop cables) entering the closure via an upper region 42 of the cable organizer 34.

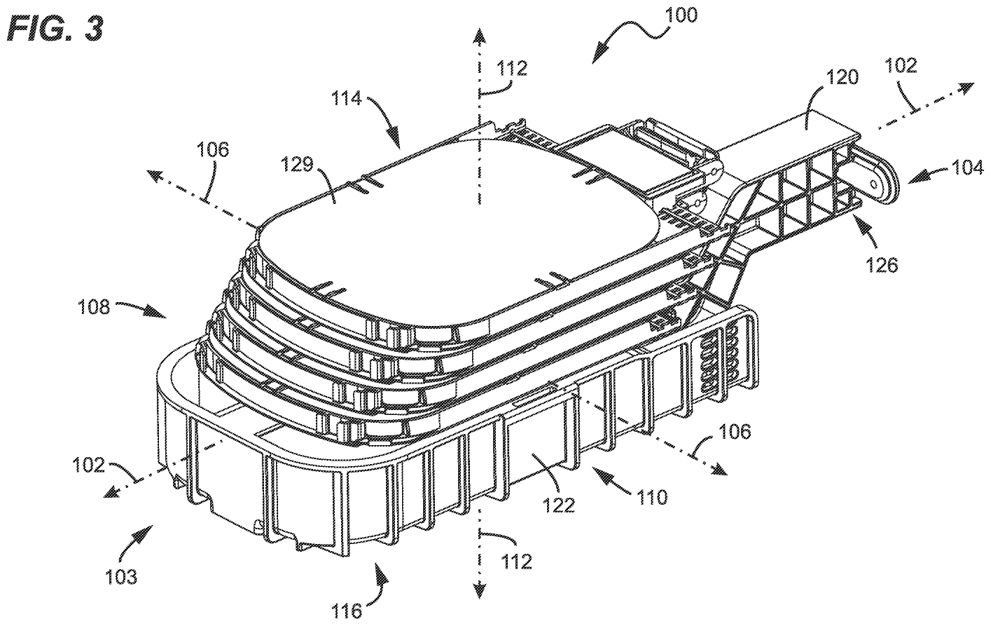

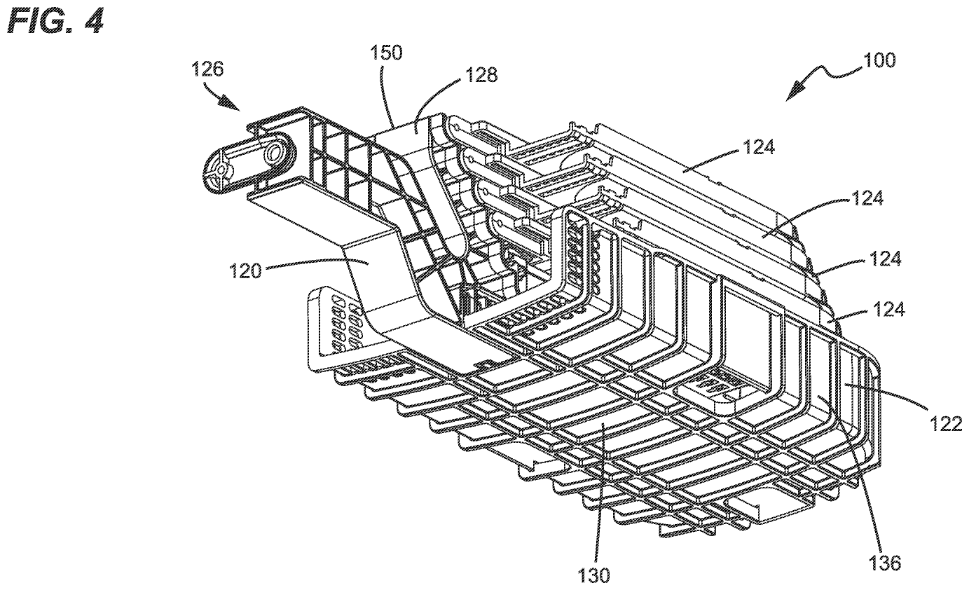

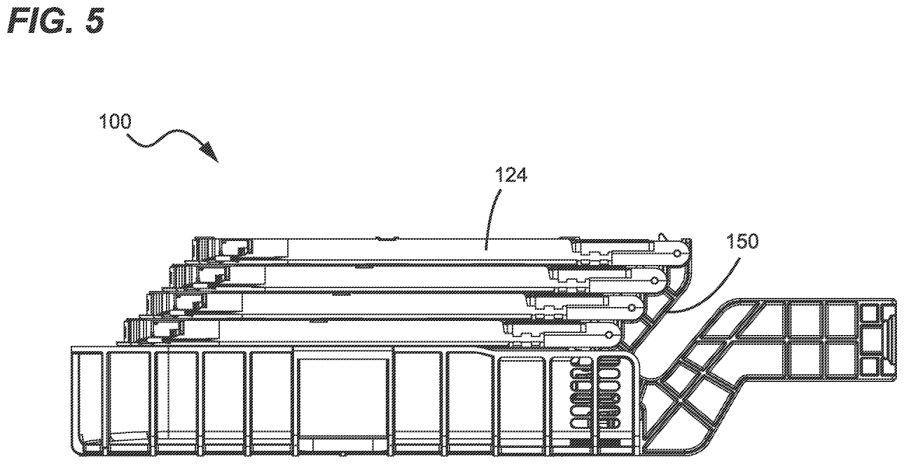

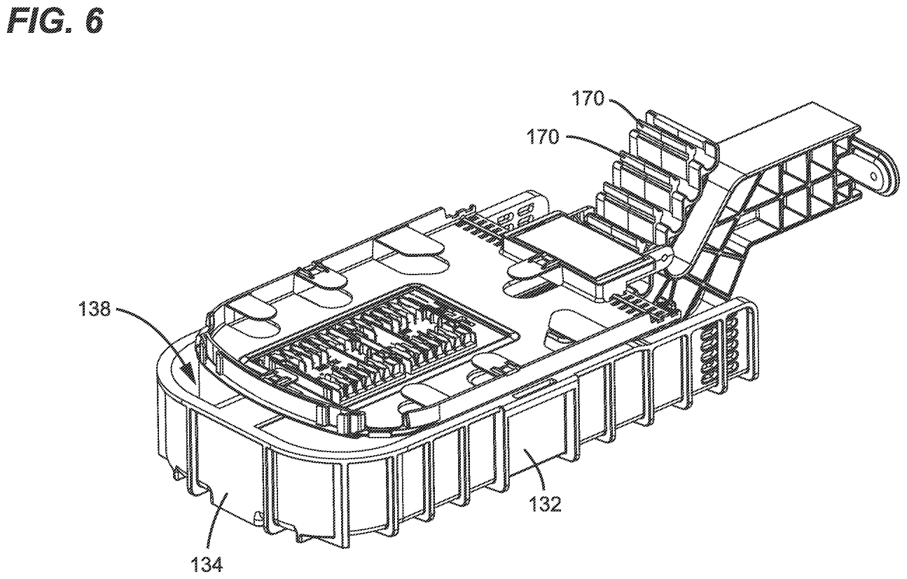

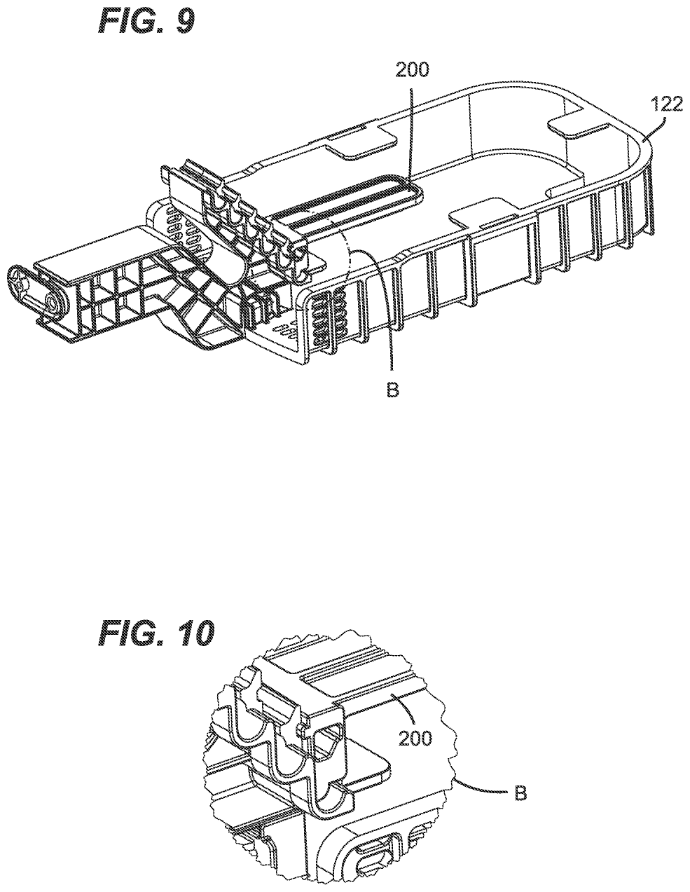

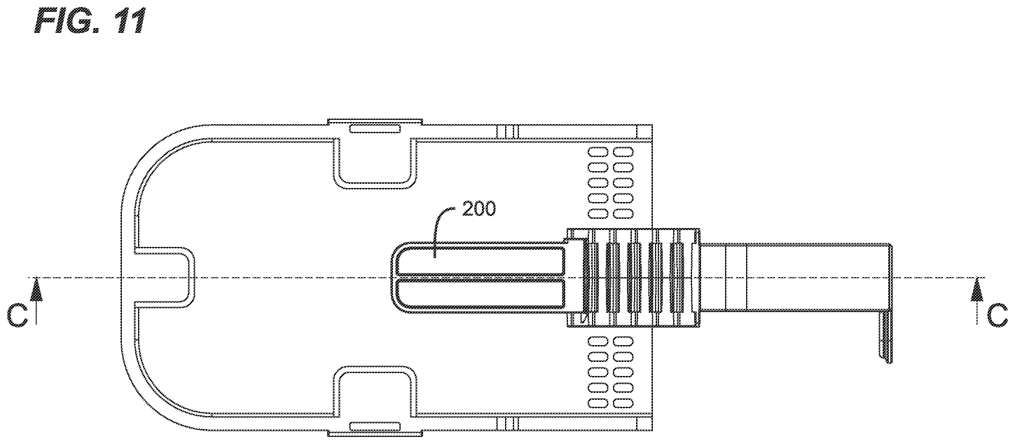

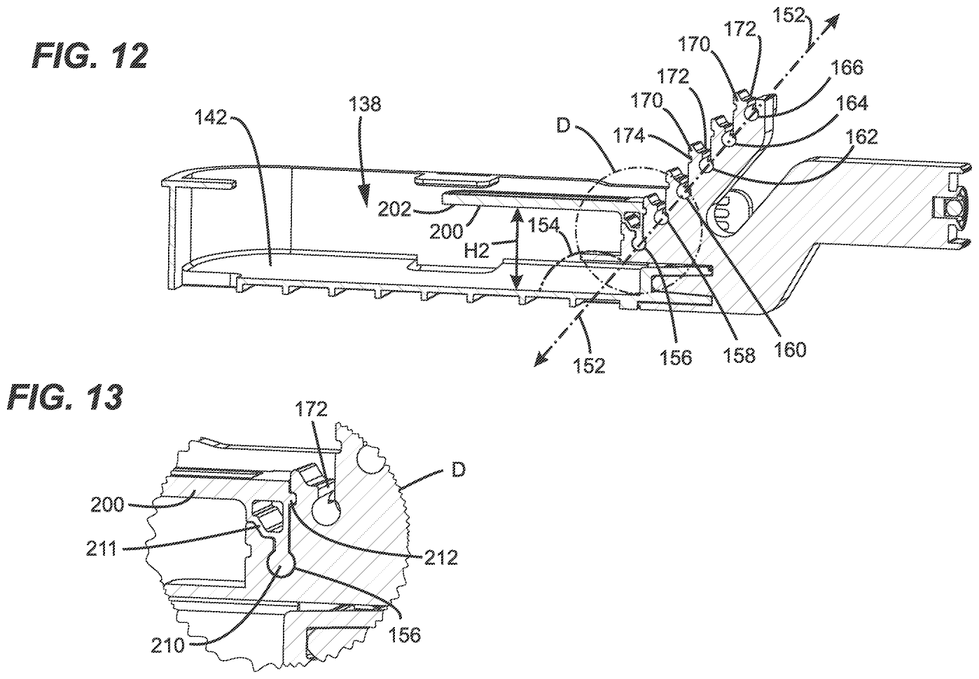

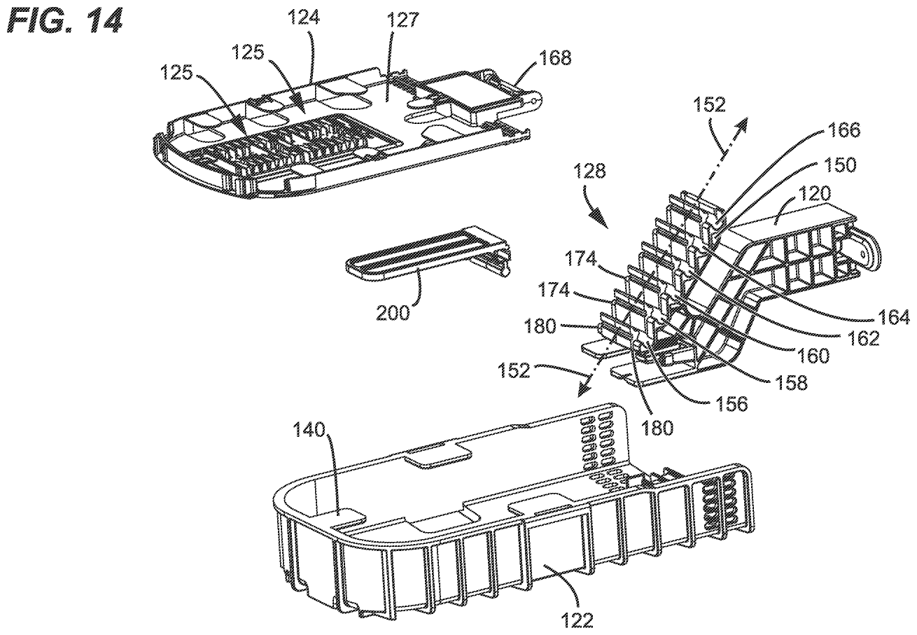

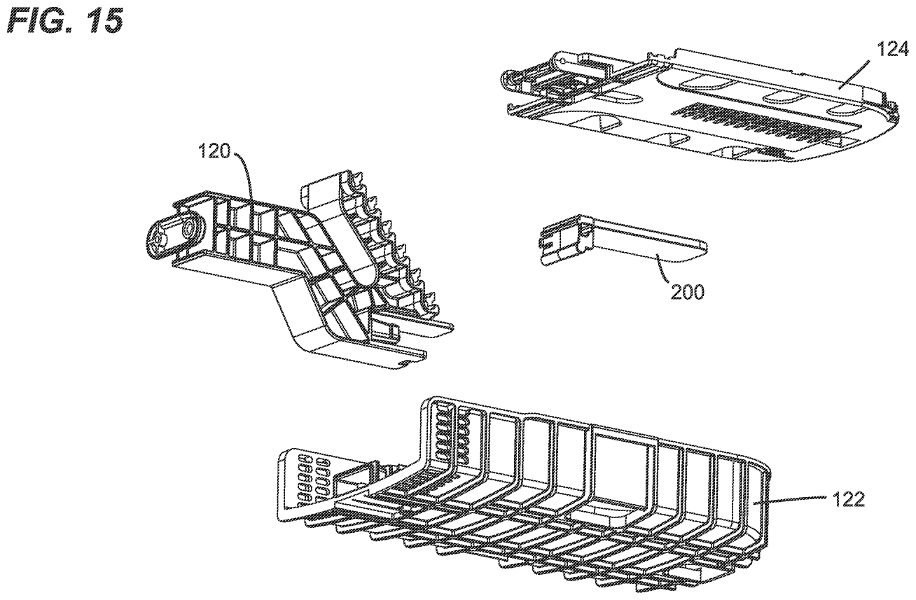

Referring now to FIGS. 3-15, a fiber management organizer (or organizer) 100 in accordance with the present disclosure will be described. The cable organizer 100 can cooperate with housing pieces of a closure such as the closure 10 described above. For example, the cable organizer 100 can cooperate with the housing pieces 30, 32 as described above with respect to FIGS. 1 and 2. The organizer 100 can be positioned in the closure volume 40 (FIGS. 1-2).

The organizer 100 extends along a longitudinal axis 102 from a distal end 103 to a proximal end 104, along a transverse axis 106 from a first side 108 to a second side 110, and along a vertical axis 112 from a top 114 to a bottom 116. The axes 102, 106 and 112 are mutually perpendicular, with the axes 102 and 106 defining a horizontal plane.

The organizer 100 includes a main body 120, a basket 122, and fiber management trays 124. The basket 122 lockingly and releasably couples to the main body 120. The basket 122 locks to the main body in a fixed position.

In some examples, the main body is unitarily constructed (e.g., seamless part made from, e.g., a single mold of polymeric material).

The main body 120 includes a mounting portion 126 and a tray support structure 128.

The tray support structure 128 pivotally supports fiber management trays 124. Each tray 124 is pivotally coupled to the tray support structure 128 at a discrete mounting location defined by the fiber tray support structure 128, such that the trays 124 are stacked one atop another along the vertical axis. To access a tray 124 below another tray 124, the tray(s) 124 above it can be pivoted to a pivoted up position. Once work on the trays 124 is complete, the trays can be pivoted to the storage position, and the organizer 100 returned to the closure.

The tray support structure 128 of the main body 120 includes a tower 150. The tower 150 defines a longitudinal axis 152. When the main body 120 and the basket 122 are assembled, the axis 152 extends away from the horizontal surface 142 of the basket 122 at an angle 154. In some examples, the angle 154 is an oblique angle. In some examples, the angle 154 is in a range from about 100 degrees to about 150 degrees. In some examples, the angle 154 is in a range from about 125 degrees to about 145 degrees. The tower 150 defines hinge sockets 156, 158, 160, 162, 164, 166 aligned with one another parallel to the axis 152.

Each socket is configured to receive and pivotally retain a hinge pin 168 of a tray 124. Each socket is partially defined by an arm 170 having a projecting lip 172. Each arm 170 also includes a groove 174 on a distal side of the arm 170. To mount a tray 124 to the tower 150, the tray's hinge pin 168 is pressed downward in a selected one of the sockets 156, 158, 160, 162, 164, 166, causing the distally corresponding arm 170 to flex distally. The pin 168 then clears the corresponding lip 172 and is snappingly received in the socket as the arm 170 resiliently returns to its unflexed position. In this position the corresponding lip 172 can help retain the pin 168 in the socket. Within the socket, the pin can rotate about a rotation axis lying in a horizontal plane. The sockets 156, 158, 160, 162, 164, 166, including each socket's corresponding arm 170 and lip 172 are identically constructed.

The mounting portion 126 is configured to mount the main body 120 (and thereby the organizer 100) to a cable fixation base (not shown). Cables entering a closure can be fixed to a cable fixation base positioned within the interior volume of the closure. Optical fibers are routed from the cables on the organizer 100. The fibers can be routed to different portions of the organizer 100 depending on specific connectivity needs between provider side cables (e.g., feeder cables) and subscriber side cables (e.g., drop cables), as well as between different branch cables, or between feeder cables and branch cables. Branch cables typically can be used to route optical fibers between different closures. Fibers from a single feeder cable can be routed to multiple drop cables at a closure.

The organizer 100 includes structures for organizing optical fibers. For example, the trays 124 are configured to support fiber management components, such as optical signal splitters, wave division multiplexers, adapters that are configured to receive and optically connect connectorized fibers, and splice holders. Splice holders, such as the splice holders 125 mounted to the fiber management surface 127 of each tray 124, typically include a body defining slots configured to secure splice bodies that protect splices (e.g., mechanical splices, fusion splices) between fibers (e.g., between a feeder cable fiber and a drop cable fiber). Optionally, one or more of the trays 124 can be fitted with a protective cover 129 that covers the fiber management surface 127 of the tray and is configured to protect the fibers managed on the fiber management surface 127.

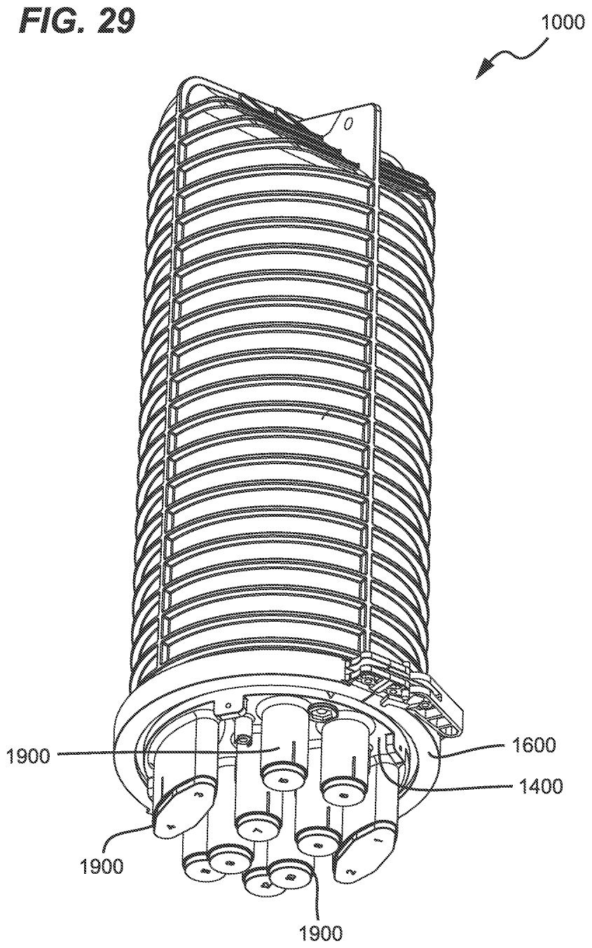

Fibers can be routed from the cables to the basket 122. The basket 122 includes a bottom wall 130, and sidewalls 132, 134, 136 that, together with the bottom wall 130, define an interior basket volume 138. Loops and/or portions of loops of optical fibers can be stored in the interior basket volume 138 (see FIG. 27). In addition, axial lengths of optical fibers can be routed through the basket volume 138 for improved routing and alignment of the fibers at the trays 124. Stored fibers can be stored in the basket volume 138 until optical connectorization of those fibers is needed. Lengths of fibers that enter and exit the closure via cables without being managed on the fiber management trays 124 can also be positioned in the basket volume 138.

The fibers stored in, and/or routed through the basket volume 138, can be loose, ribbonized, and/or positioned in protective sheaths (e.g., plastic tubes) holding a single fiber or a group of fibers.

The number and volume or collection of fibers positioned in the basket 122 can vary based on the connectivity needs at a given closure. In addition, a different sized basket (e.g., one having a basket volume that can accommodate more or fewer fibers than the basket 122) can be used and coupled to the same main body 120.

To protect the collection of fiber lengths positioned in the basket volume 138 from tangling with fibers external to the basket, as well as from twisting of fibers, from catching of fibers on portions of the organizer, and/or from fibers experiencing undesirable load forces, it is preferable to physically retain the collection of fiber lengths within the basket 122.

The basket 122 includes tabs 140 projecting horizontally from upper portions of the sidewalls 132, 134, 136 and parallel to the fiber surface 142 of the bottom wall 130. The tabs 140 have a fixed height H1 above the surface 142. Thus, the tabs 140 cannot be adjusted to accommodate different fiber collection sizes. Thus, for example, collections of fiber lengths in the basket 122 that cannot fill the height H1 can be inadequately constrained by the tabs 140, causing portions of fibers of the collection undesirably to escape (e.g., stick out of) the basket volume 138. In another example, collections of fiber lengths in the basket 122 are too large to be contained between the surface 142 and the tabs 140, causing portions of the fibers undesirably to escape (e.g., stick out of) the basket volume.

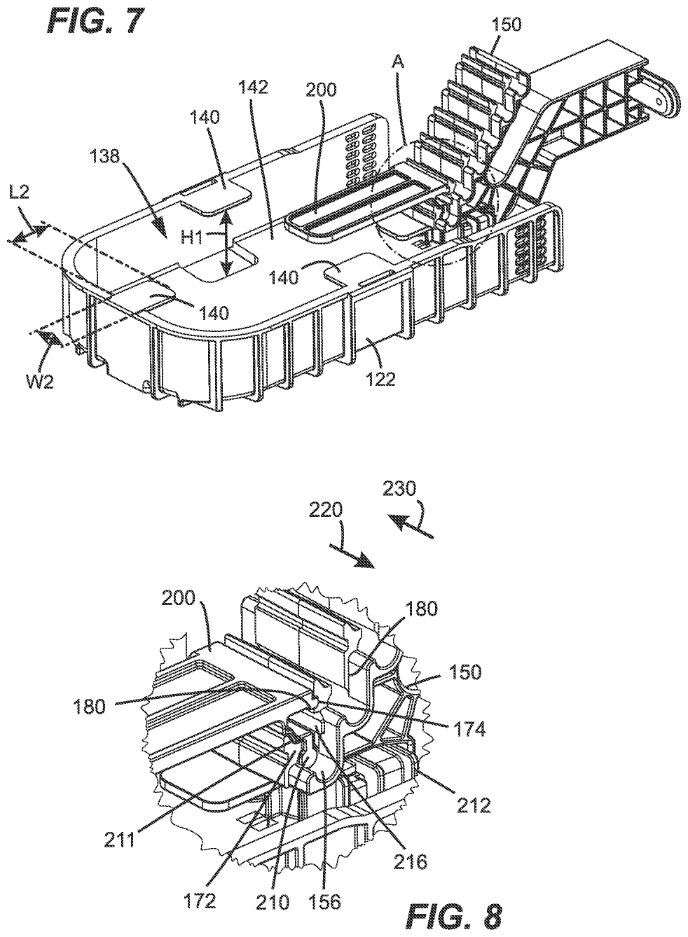

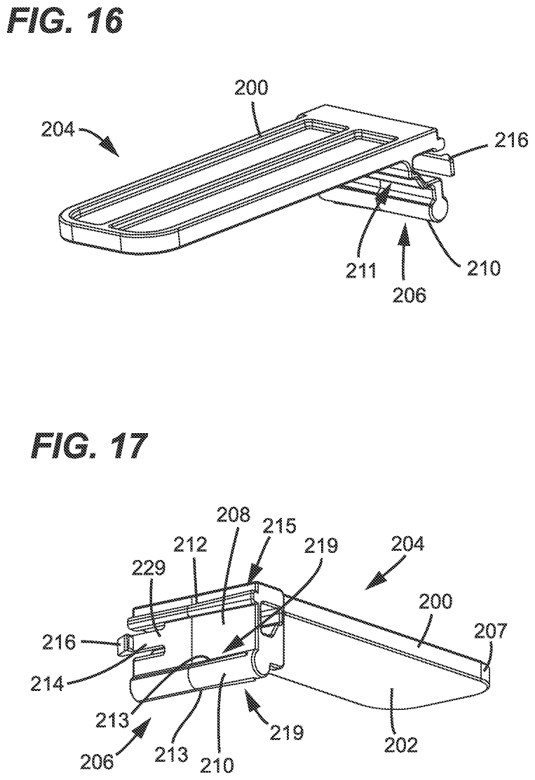

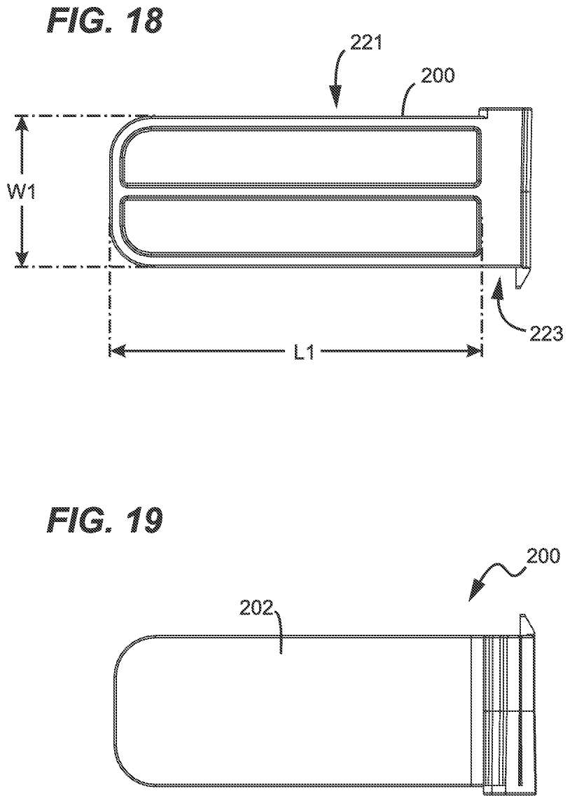

To enhance the versatility of the basket 122, the organizer 100 includes a customizable basket optical fiber retainer. Referring to FIGS. 7-19 and 27, a basket optical fiber retainer (or, retainer) 200 is illustrated. The retainer 200 is configured to be lockingly mounted to the tower 150 at any of multiple mounting locations defined by the tower 150. Specifically, each socket 156, 158, 160, 162, 164, 166 defines a mounting location for lockingly mounting the retainer 200. Typically, the retainer 200 is mounted to the socket 156, 158 or 160, and trays 124 are pivotally mounted to one or more of the sockets above the retainer 200.

By selecting a desired one of the sockets to mount the retainer 200, a height H2 between the surface 142 and the retaining surface 202 can be adjusted relative to the height H1. The socket for mounting the retainer can be selected for a given use application based on the number of trays 124 to be mounted to the tower 150 and the volume of fibers to be stored or otherwise positioned in the basket 122. For example, the height H2 can be selected to be greater than, equal to, or less than the height H1 based on one or more of these factors. Referring to FIG. 27, the retainer 200 has been mounted to a mounting location of the tower 150 such that the distance between the support surface of the basket 122 and the tabs 140 is substantially equal to the distance between the support surface of the basket 122 and the retaining surface of the retainer 200.

The retainer 200 is versatile in its ability to lockingly mount to different mounting locations of the tower 150 depending on fiber volume and routing needs.

The retainer 200 is also versatile in its ability to lockingly interface with the same feature(s) (e.g., the hinge sockets) of the tower 150 with which the trays 124 interface to pivotally mount to the tower 150.

Yet another advantage provided by the retainer 200 is the retainer's relatively large size as compared with that of the tabs 140. The tabs 140 are positionally fixed to the sidewalls 132, 134, 136 of the basket 122. Therefore, the size of the tabs 140 is minimized to allow loading, looping, routing, and other handling of fibers within the basket volume 138 with minimal interference by the tabs 140. A disadvantage of the relatively small size of the tabs 140 is the accompanying reduction in their ability to retain fibers that do not pass under them. For example, relatively small loops of fiber (such as the loops 190 shown in FIG. 27) positioned in the basket 122 may not be sized to be adequately retained by the tabs 140.

The retainer 200, on the other hand, is configured to be installed after fibers have been loaded and handled in the basket 122. This allows the retainer 200 to be significantly larger than the tabs 140, and thereby provide improved retention of fibers in the basket 122.

For example, the retainer 200 has a greatest retention length L1 and a greatest retention width W1 that is perpendicular to L1. L1 and W1 are defined by the retaining portion 204 of the retainer 200. In contrast, the longitudinally opposing tab 140 (FIG. 7) has a greatest retention length L2, corresponding to the dimension L1, and a greatest retention width W2, corresponding to the dimension W1. In some examples, L1 is at least two times, at least three times, at least four times, or at least five times the size of L2. In some examples, W2 is at least two times, at least three times, at least four times, or at least five times the size of W1. In some examples, the length L1 is at least on fifth, or at least one fourth, or at least one third, or at least one half the corresponding maximum length of the surface 142. In some examples, the width W1 is at least on fifth, or at least one fourth, or at least one third, or at least one half the corresponding maximum width of the surface 142.

The retainer 200 includes the retaining portion 204 and a mounting portion 206. The mounting portion 206 is positioned proximally to the retaining portion. In some examples, the retaining portion 204 and the mounting portion 206 are of unitary, seamless construction. For example, the retainer 200 can be formed in a single mold of polymeric material. The retaining portion 205 includes a retaining body 207 defining the horizontal retaining surface 202 described above.

The mounting portion 206 includes a mounting body 208. The mounting body 208 includes a socket coupling member 210, a support surface 211, a rib 212, and a resilient latch arm 214 having a catch 216.

The rib 212 has a taper 215 such that the rib 212 gradually widens towards the side 221 of the retainer 200 that is opposite the side 223 where the catch 216 is positioned. The rib 212 extends parallel to and spans the entire width dimension W1.

The socket coupling member 210 also includes ribs 213. The ribs 213 have tapers 219 such that the ribs 213 widen toward the side 221.

These features are configured to securely and removably mount the retainer 200 to a selected one of the mounting locations partially defined by the hinge sockets of the tower 150.

For example, referring to FIG. 8, to mount the retainer 200 to the tower 150 at the mounting location partially defined by the socket 156, the retainer 200 is slid horizontally in the direction of the arrow 220 into engagement with the tower 150. The socket coupling member 210 is complementarily shaped and sized to be received by the socket 156. The support surface 211 is shaped and sized complementarily to, and abuts, the lip 172 and the adjacent surfaces of the tower 150. The rib 212 is complementarily shaped and sized to be received in the groove 174. Thus, sliding the retainer 200 in the direction of the arrow 220 causes the rib 212 to slide in the groove 174 and the socket coupling member to slide in the socket 156.

In addition, while sliding the retainer 200 in the direction 220, a wedge effect is created between the widening portions of the ribs 212, 213 and the abutting surface of the groove 174 and the socket 156, respectively, resisting further sliding of the retainer 200 in the direction 220 beyond the locked position shown in FIG. 8.

These complementary interfaces between the retainer 200 and the tower 150, together with an abutment of the support surface 211 and the complementary surfaces of the tower 150 at the selected mounting location support the retainer 200 at the mounting location and minimize movement of the retainer 200 relative to the tower 150 in all directions except for the direction 230 that is opposite the installing direction 220.

To resist undesired sliding of the retainer 200 in the direction 230, the catch 216 engages a shoulder 180 defined by the tower 150. As the retainer 200 is slid for installation in the direction 220, the latch arm 214 flexes distally about its fixed end 229. Once the catch 216 clears the shoulder 180, the latch arm 214 resiliently returns to its unflexed position, causing the catch 216 to engage the shoulder 180, and thereby locking the retainer 200 to the tower 150. To remove the retainer 200 from the tower 150, a tool or a finger can be used to disengage the catch 216 from the shoulder 180, and the retainer 200 can then be slid in the direction 230 out of engagement with the tower 150.

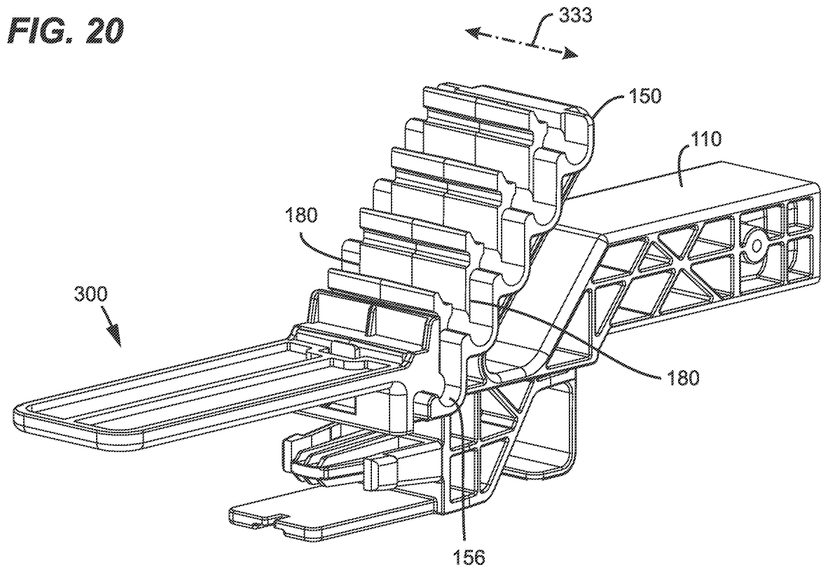

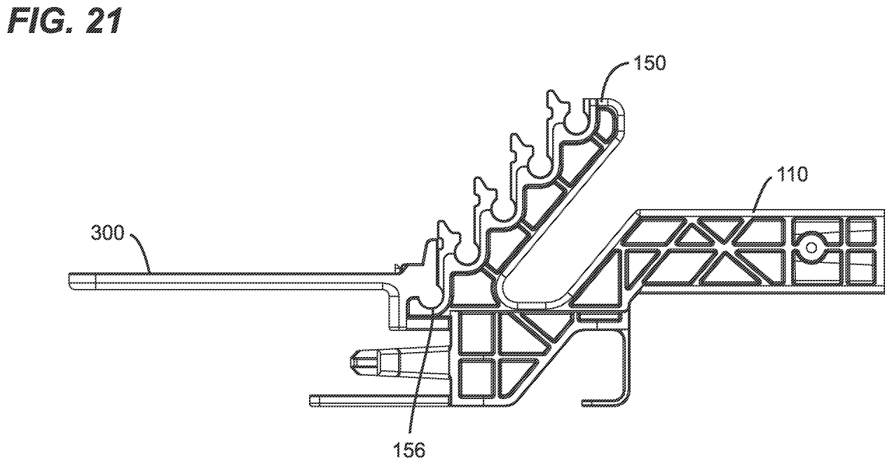

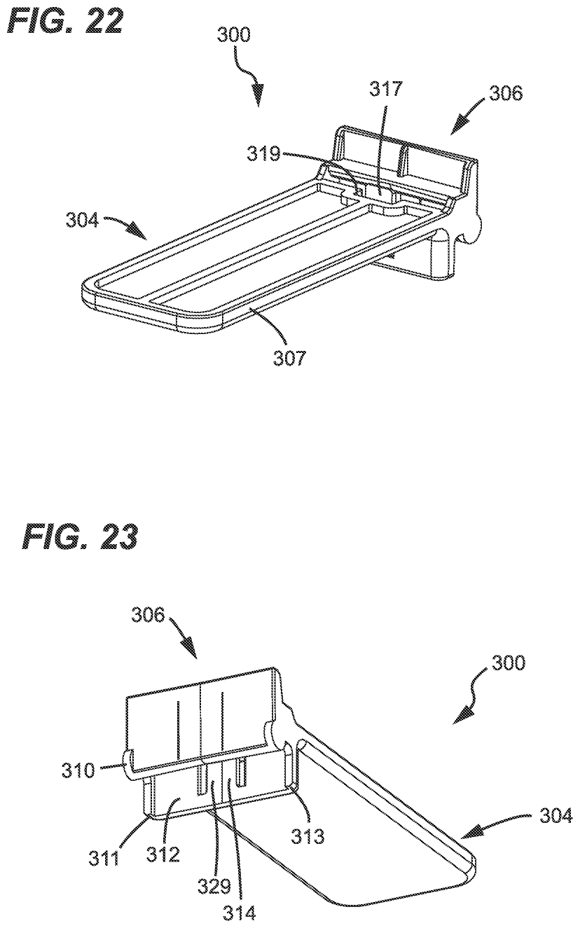

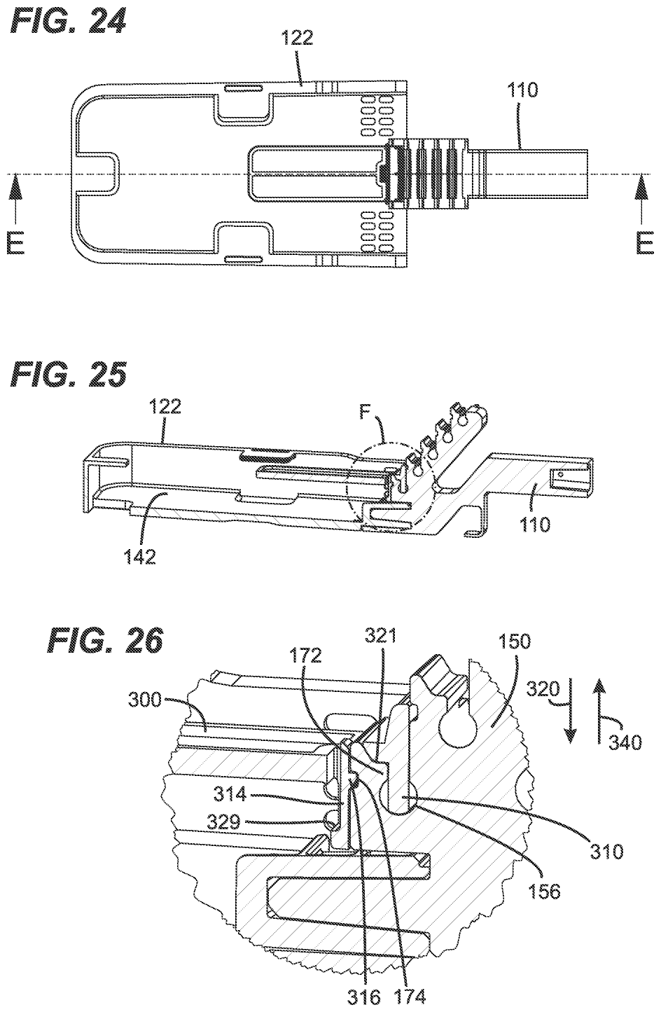

Referring to FIGS. 20-26, a further example of a fiber retainer 300 that can be mounted to a selected mounting location defined partially by a hinge socket of the tower 150 will be described. The purpose and operating principles of the retainer 300 are the same as those of the retainer 200. The retainer 300 differs from the retainer 200 in the manner in which the retainer 300 mounts to the tower 150. The following discussion with therefore primarily focus on mounting of the retainer 300 to the tower 150.

The retainer 300 includes a retaining portion 304 and a mounting portion 306. In some examples, the retaining portion 304 is structurally identical to the retaining portion 204 of the retainer 200 described above.

The mounting portion 306 is positioned proximally to the retaining portion. In some examples, the retaining portion 304 and the mounting portion 306 are of unitary, (e.g., seamless) construction. For example, the retainer 300 can be formed in a single mold of polymeric material.

The mounting portion 306 includes a mounting body 308. The mounting body 308 includes a socket coupling member 310, a support surface 312, shoulders 311 and 313 projecting from, and at opposite sides of, the support surface 312, and a resilient latch arm 314 connected to the support surface 312 and having a catch 316. A free end portion 317 of the latch arm 314 extends upward through an opening 319 defined by the retaining body 307 of the retaining portion 304. The free end portion 317 is accessible, e.g., with a finger or a tool to flex the latch 314 in order to remove the retainer 300 from the tower 150.

These features and other surfaces of the mounting portion 306 are configured to securely and removably mount the retainer 300 to a selected one of the mounting locations partially defined by the hinge sockets of the tower 150.

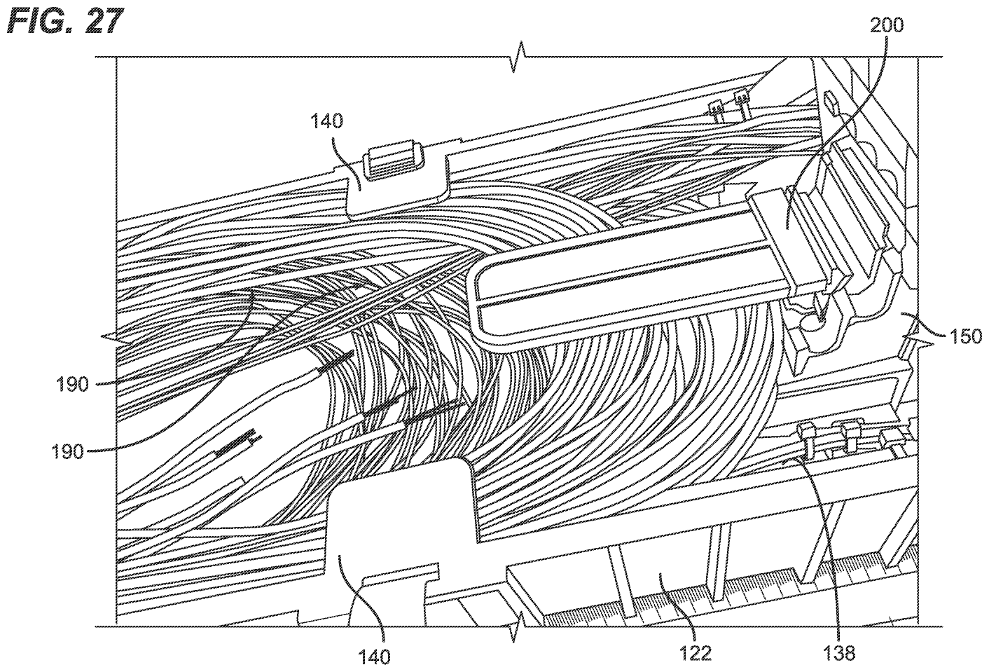

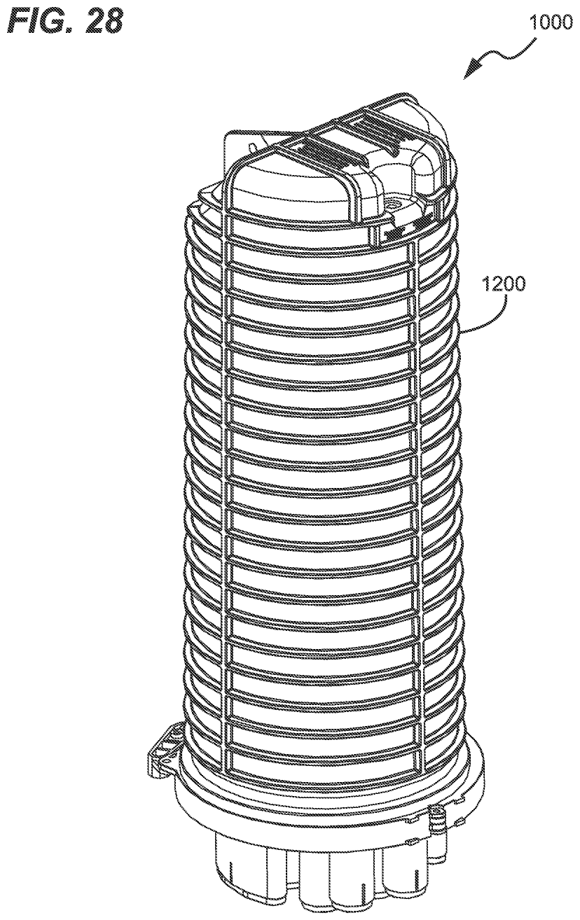

For example, referring to FIG. 26, to mount the retainer 300 to the tower 150 at the mounting location partially defined by the socket 156, the retainer 300 is slid vertically in the direction of the arrow 320 into engagement with the tower 150. The socket coupling member 310 is received by the socket 156. The support surface 321 is shaped and sized complementarily to, and abuts, the lip 172 and the adjacent surfaces of the tower 150. The catch 316 engages the groove 174. Thus, sliding the retainer 300 in the direction of the arrow 320 causes the catch to engage the groove 174 and the socket coupling member 310 to slide into the socket 156. In addition, the shoulders 311 and 313 engage outer surfaces of the opposite shoulders 180 of the tower 150 at the selected mounting location, inhibiting side to side movement of the retainer 300 relative to the tower 150 in the directions represented by the arrows 333.

These complementary interfaces between the retainer 300 and the tower 150, together with an abutment of the support surface 321 and the complementary surfaces of the tower 150 at the selected mounting location support the retainer 300 at the mounting location and minimize movement of the retainer 300 relative to the tower 150 in all directions.

As mentioned briefly above, to resist undesired sliding of the retainer 300 upward in the direction 340, the catch 316 engages the groove 174 defined by the tower 150. As the retainer 300 is slid for installation in the direction 320, the latch arm 314 flexes distally about its fixed end 329. Once the catch 316 is clear to enter the groove 174, the latch arm 314 resiliently returns to its unflexed position, causing the catch 316 to enter and engage the groove 174, thereby locking the retainer 300 to the tower 150. To remove the retainer 300 from the tower 150, a tool or a finger can be used to flex the arm 314 distally to disengage the catch 316 from the groove 174, and the retainer 300 can then be slid upward in the direction 340 out of engagement with the tower 150.

In an example method of using a customizable fiber retainer (such as the retainer 200, 300) to retain optical fibers positioned in a basket of an optical fiber organizer of a fiber optic closure, in a first step optical fibers are arranged in the basket. In a second step prior to or subsequent to the first step, one of a plurality of mounting locations on a tray support structure is selected, the tray support structure being configured to pivotally mount fiber management trays. In a third step subsequent to the second step, the retainer is lockingly mounted to the tray support structure at the selected mounting location.

In some examples, the mounting location is selected based on a number of fiber management trays to be mounted to the tray support structure.

In some examples, the mounting location is selected based on a quantity or volume of the fibers positioned in the basket.

In some examples, in a subsequent step, the retainer is removed from the mounting location. In some examples, the removed retainer is subsequently mounted to a different one of the mounting locations defined by the tray support structure.

Referring to FIGS. 28-29, further example telecommunications equipment 1000 is shown. In the depicted example, the equipment 1000 includes a sealable and re-enterable closure. In other examples, the equipment can include other components at a distribution location of an optical fiber network. Such equipment can include, for example, a cabinet, a drawer, a shelf, or a panel for organizing and routing optical fibers.

The closure 1000 includes a first housing piece 1200 (in this case, a substantially frustoconical dome), and a second housing piece 1400 configured to cooperate with the first housing piece 1200 to define a sealable and re-enterable telecommunications closure for managing optical fibers. The first and second housing pieces 1200, 1400 define an interior closure volume in which other fiber managing equipment, including an optical fiber management organizer according to the present disclosure, can be positioned.

A clamp ring 1600 having a clamp can be used to clamp and seal together the housing pieces 1200 and 1400.

Cables carrying optical fibers can enter the closure volume via sealable ports 1900 defined by the second housing piece 1400. Such cables can include trunk cables, feeder cables, branch cables, and distribution cables (also known as drop cables).

In addition to splicing, other fiber management activities can be performed with components of the optical fiber organizer housed within the closure volume. Such activities can include, without limitation, indexing fibers, storing fibers (typically in one or more loops) and splitting fibers.

The cables entering the closure 1000 can include optical fibers of different configurations such as loose fibers and fiber ribbons. The fiber ribbons can be flat ribbons or rollable ribbons. The loose fibers can be individual fibers or bundled loose fibers protected by a common protective sheath or tube. For fiber ribbons, the fibers of the entire ribbon can be spliced to the fibers of a corresponding fiber ribbon at the same time, e.g., using a mass fusion splicing procedure.

Splice bodies protect the splices both in the case of individual fiber splices and in the case of mass fiber splices, such as mass fusion splices. The splice bodies are held in splice holders also known as splice chips. Fiber management trays of a fiber management assembly (also referred to as an organizer) positioned in the interior sealable and re-enterable volume defined by the closure 1000 can support such splice holders (or chips).

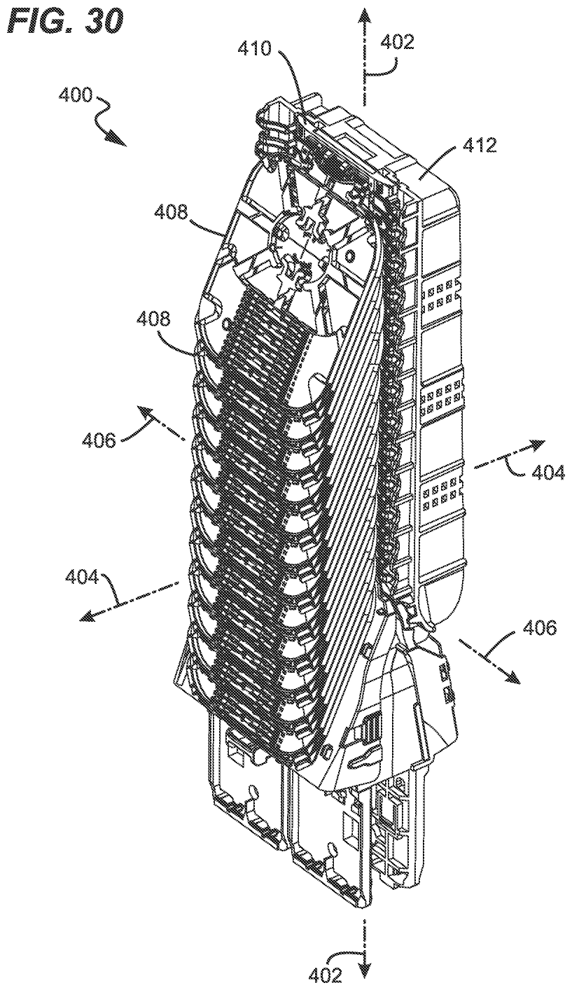

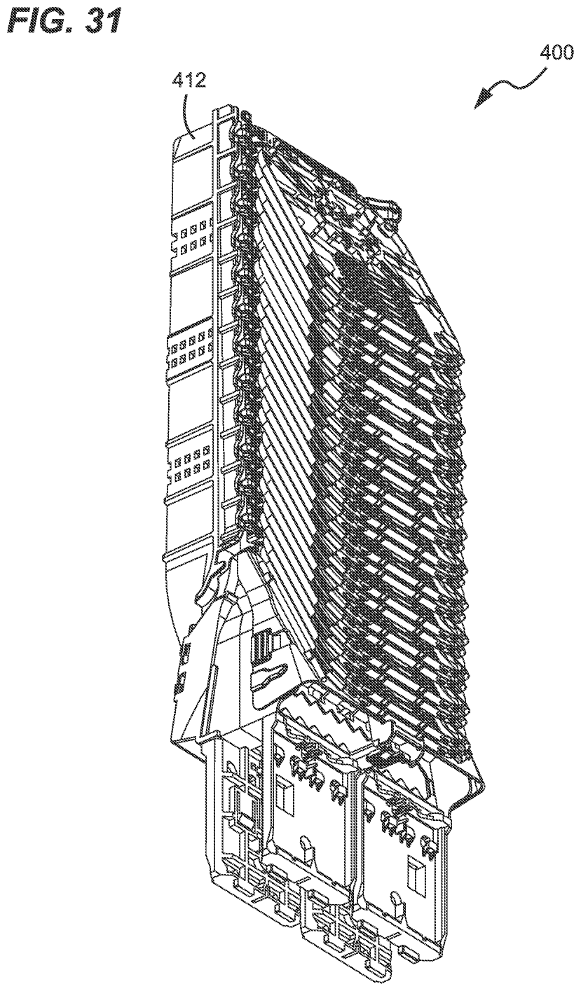

Referring to FIGS. 30-33, the optical fiber organizer 400 is configured to be housed in the closure volume of the closure 1000 (FIG. 28).

The organizer 400 defines a first axis 402, a second axis 404 and a third axis 406 that are mutually perpendicular to one another.

The organizer 400 includes pivotally mounted fiber management trays 408 (e.g., trays that can support optical fiber splices and other optical fiber components) that are pivotally supported by tray modules 410 and arranged in a stack that defines a stacking axis that is parallel to the axis 402. The tray modules are mounted to a back side of a basket 412. The basket 412 is configured to store loops of optical fibers. The fiber loops can be loops of inactive fibers and/or slack of active fibers.

The basket 400 includes a main support surface 414. Extending from the main support surface 414 is a wall 416. The wall 416 extends from the support surface 414 along a direction perpendicular to the axis 404. The wall 416 has an inner surface 418 that, together with the support surface 414, define a basket volume 420. A height dimension 422 of the wall 416 is perpendicular to the axis 404. The height dimension 422 defines or height of the basket volume 420.

The basket 412 includes a fiber entryway 424 defining a gap in the wall 416 at one end of the basket 412. Fibers and/or sheaths holding fibers enter and exit the basket volume via the entryway 424. Fixed opposing fiber retainer lips 426 and 428 are positioned to retain fibers between the lips 426, 428 and a surface 430 of a fiber routing module 432 of the organizer 400 as the fibers enter and exit the basket 416 through the entryway 424. To improve fiber retention and routing, the elongate dimensions of the lips 426, 428 are oblique to the axes 402 and 406.

Another fixed retainer lip 432 extends parallel to the axis 402 from the wall 416 at the opposite end of the basket 412. In alternative examples, the retainer 432 is not fixed, but can be adjusted in height relative to the basket volume 420. The fixed retainer lip 432 is configured to retain fibers between the lip 432 and the surface 414 of the basket.

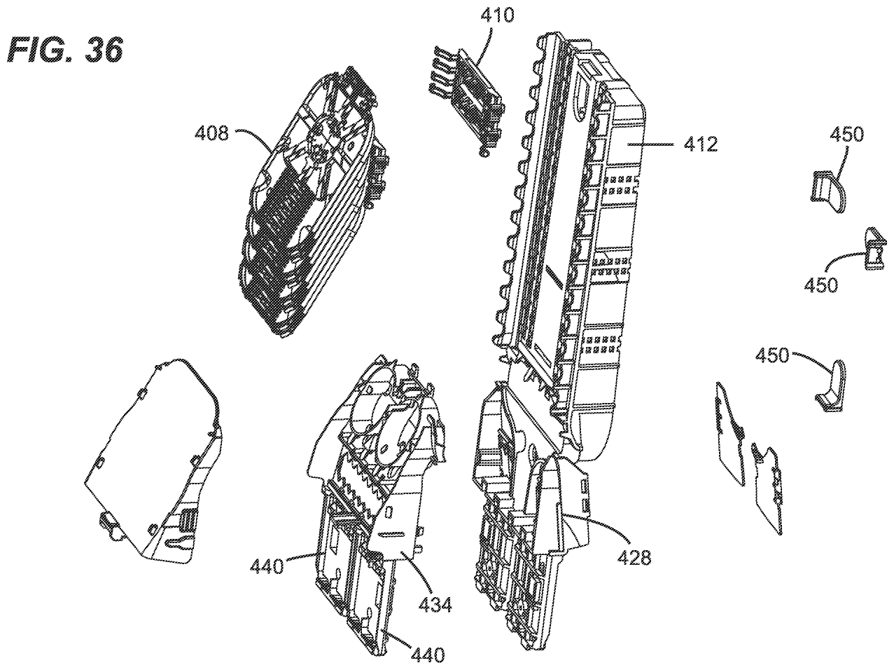

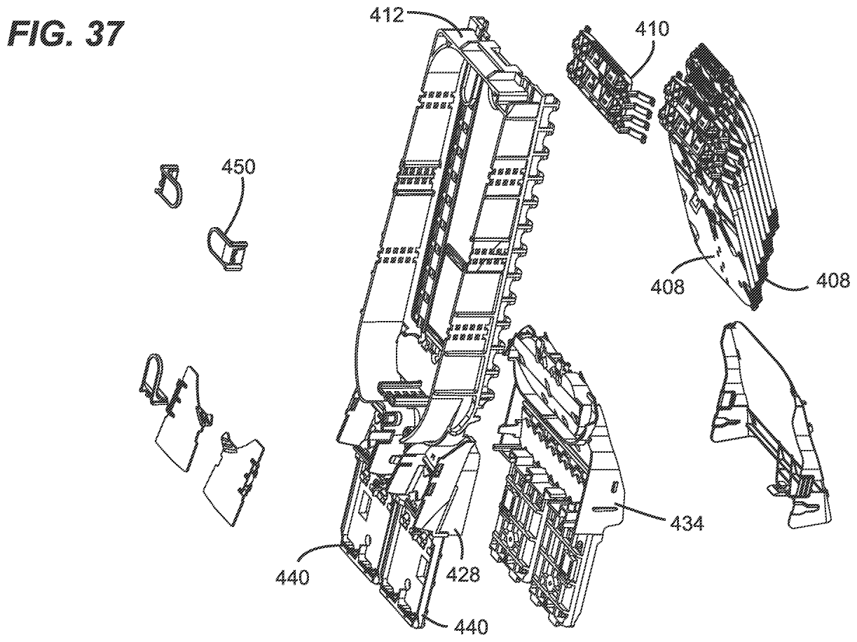

Referring to FIGS. 36-37, the organizer 400 also includes the fiber router 428. The fiber router 428 can be integrally formed (e.g., of unitary, seamless construction) with the basket 412. The fiber router 428 snap connects back-to-back with another fiber router 434.

Integrally formed with each fiber router 428, 434 are plates 440 for supporting cable jacket termination subassemblies. The plates 440 include mounting features for mounting cable jacket termination subassemblies. Such subassemblies are configured to fix end portions of the cables entering the closure, including cable strength members and the cable jackets, so that the optical fibers can extend from the ends of the cable jackets for routing and organization on the rest of the organizer 400 without being subjected to lateral loads imparted on the cables themselves.

The fiber routers 428, 434 are configured to mount sheath holders that hold and protect optical fibers extending from fixed cable jackets that are fixed with cable jacket termination subassemblies to the plates 440. The sheath holders fix portions of sheaths, which can minimize the bare fibers' being subjected to lateral load on the sheaths. The bare optical fibers or sheathed optical fibers can then be routed via the spooling structures and other fiber guide features of the fiber routers 428, 434 into the basket volume 420 and/or onto a desired fiber management tray 408 via fiber channels defined by channel structures of the tray support modules 410 and the back side of the basket 412.

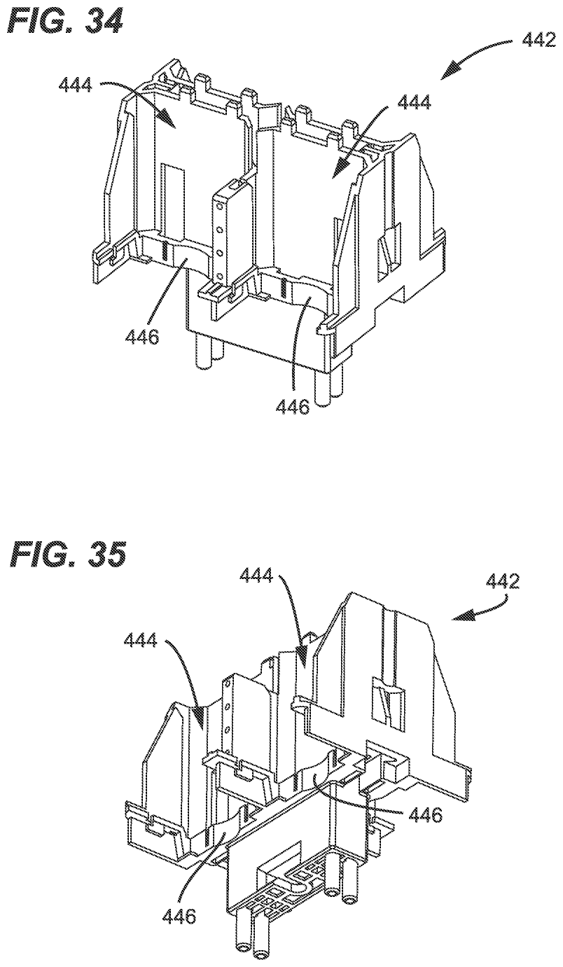

Referring to FIGS. 34-35, an example base 442 is depicted. The base 442 is configured to mount the organizer 400 and to be received within the closure volume. For example, the base defines pockets 444 that can receive via snap-lock interface the plates 440. In addition, the base 442 defines receivers 446 configured to receive sealing blocks. Such sealing blocks can seal about cable jackets as the cables enter the closure and are fixed to the plates 440.

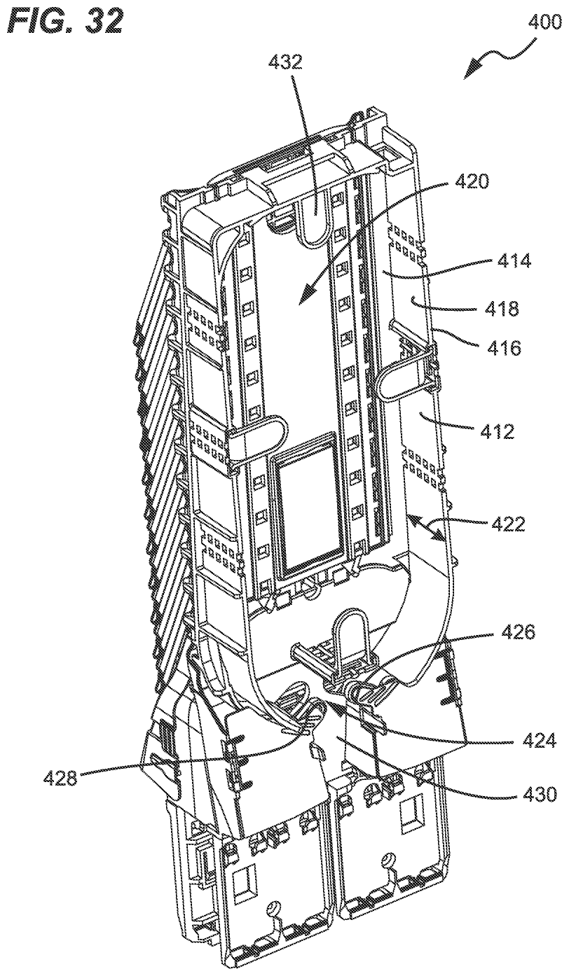

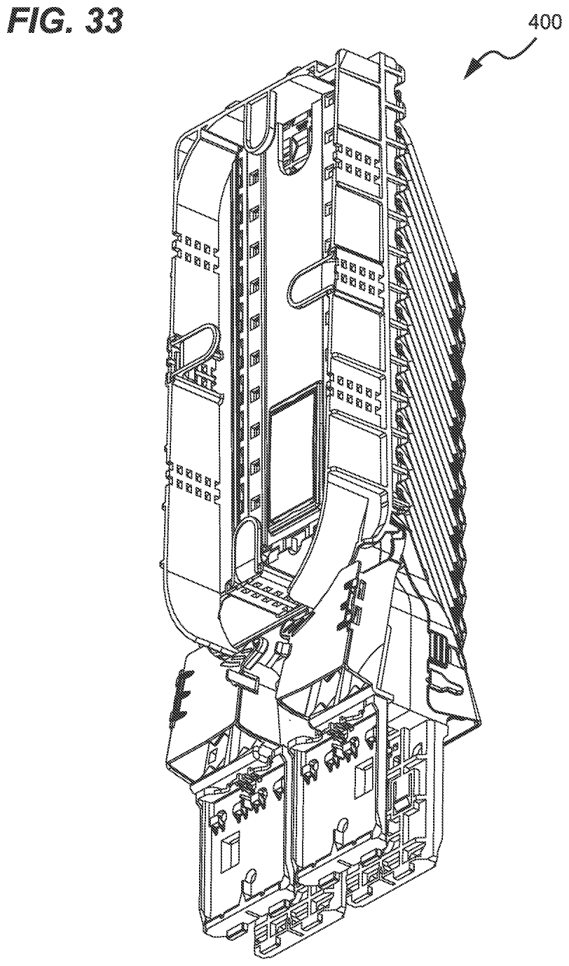

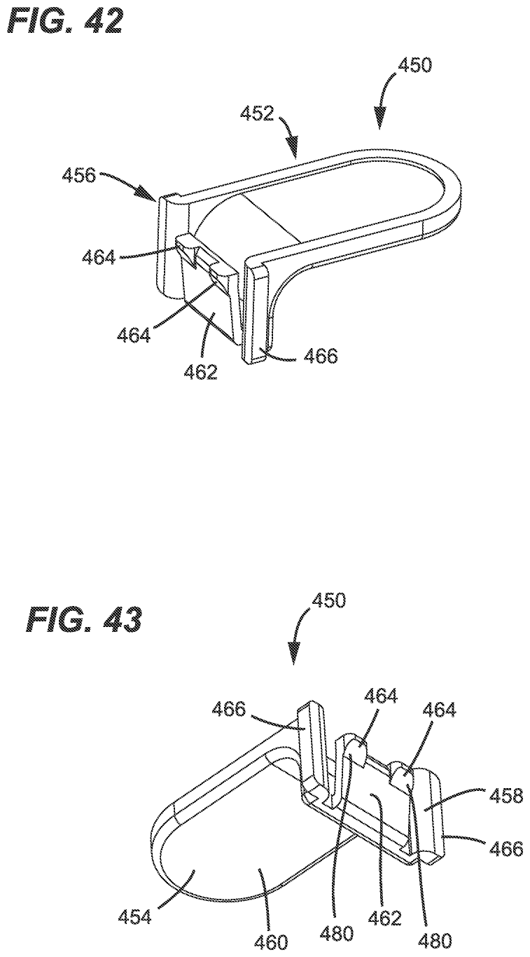

Referring to FIGS. 32, 33 and 38-43, the basket 412 includes one or more adjustable fiber retainers 450. In the example basket depicted, there are three such adjustable fiber retainers 450, though in other examples there could be one, two, four or more such adjustable retainers. In some examples, the fixed fiber retainer 432 can be replaced with an adjustable fiber retainer 450.

The adjustable retainer 450 can be a unitarily constructed part. For example, the retainer 450 can be a molded polymeric part. The adjustable retainer 450 includes a retaining portion 452 having a retaining body 454 and a mounting portion 456 having a mounting body 458. The retaining body 454 includes a retaining surface 460. When installed in the basket 412, fiber loops are retained in the basket volume 420 between the surface 460 and the surface 414, with the retaining portion 452 defining a lip extending away from the wall 416 parallel to the surface 414.

The mounting body 458 includes a flexibly resilient arm 462 from which project one or more (in this example, two) catches 464. In addition, the mounting body 458 includes a pair of opposing tabs 466.

The basket 412 includes fiber retainer receivers 470 and 472. The receivers 470 are defined by the wall 416. The receiver 472 is a standalone feature projecting from the surface 414 parallel to the axis 404 and centrally positioned relative to the fixed retainers 426 and 428. The receiver 472 is also aligned with the fixed retainer 432 along a reference line that is parallel to the axis 402.

Each receiver 470, 472 includes a pocket that defines opposing guides 474. The guides are elongate parallel to the axis 404. Each receiver 470, 472 also includes a wall 476 having fully enclosed openings 478.

To lockingly mount a retainer 450 to a receiver 470, 472 such that the retaining portion 452 is at a desired height relative to the surface 414, the tabs 466 are received in the guides 474. The retainer 450 can be slid parallel to the axis 404 until the one or more catches 464 find openings 478 at the desired height for the retainer 450. The resilient arm 462 is flexed by contact with the wall 476 and resiliently unflexes when the catches 464 can be received in openings 478. Chamfers 480 of the catches 464 can allow the retainer 450 to be slid toward the surface 414 with the tabs 466 received in the guides 474 without having to use a finger or other tool to flex the resilient arm 462.

To slide the retainer 450 away from the surface 414 with the tabs 466 received in the guides 474 and/or to remove the retainer 450 from the basket 412, the resilient arm 462 can be flexed inward (toward the retainer portion 452) to release the catches 464 from the openings 478, allowing the retainer 450 to be adjusted to a greater height relative to the surface 414 and/or to be removed entirely from engagement with the basket 412.

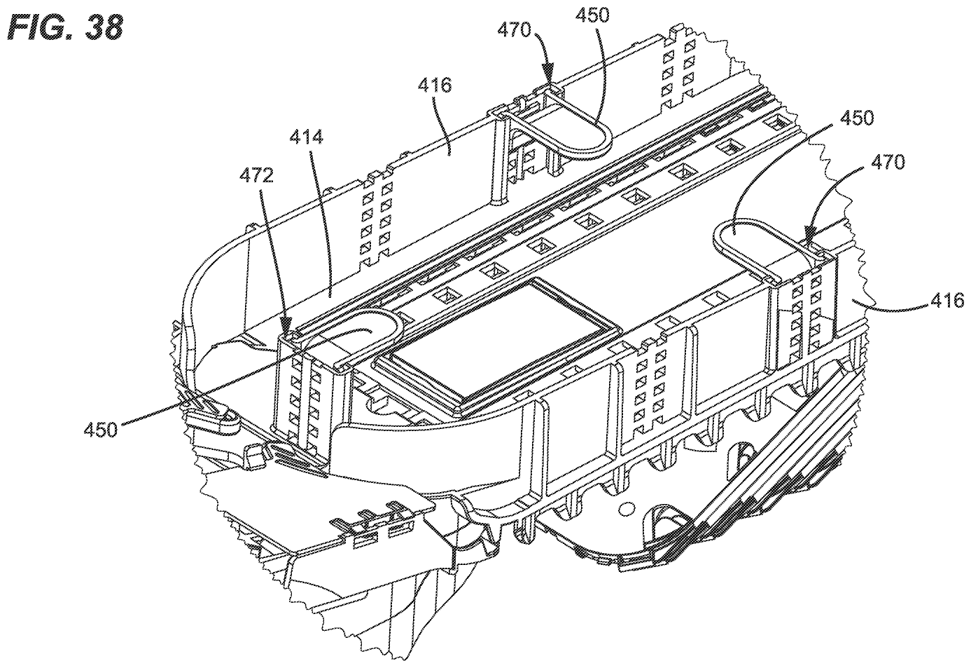

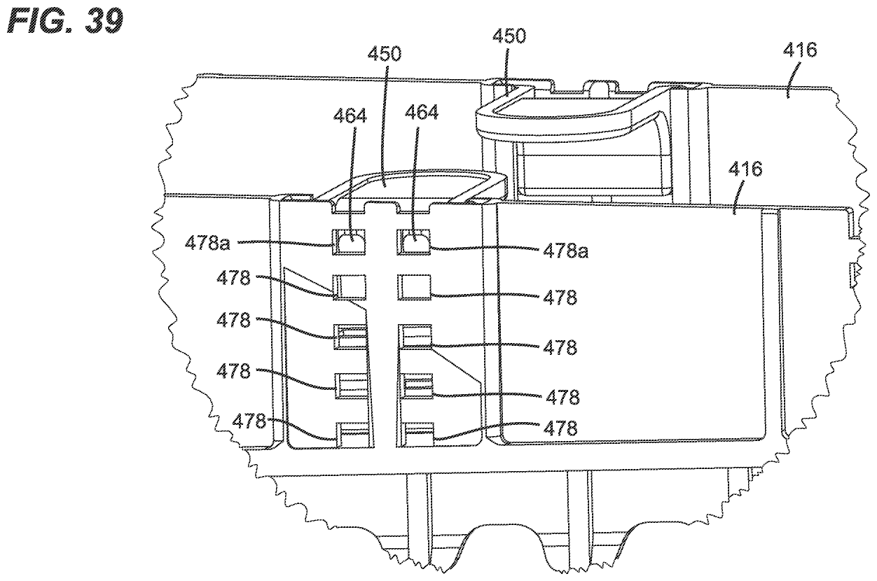

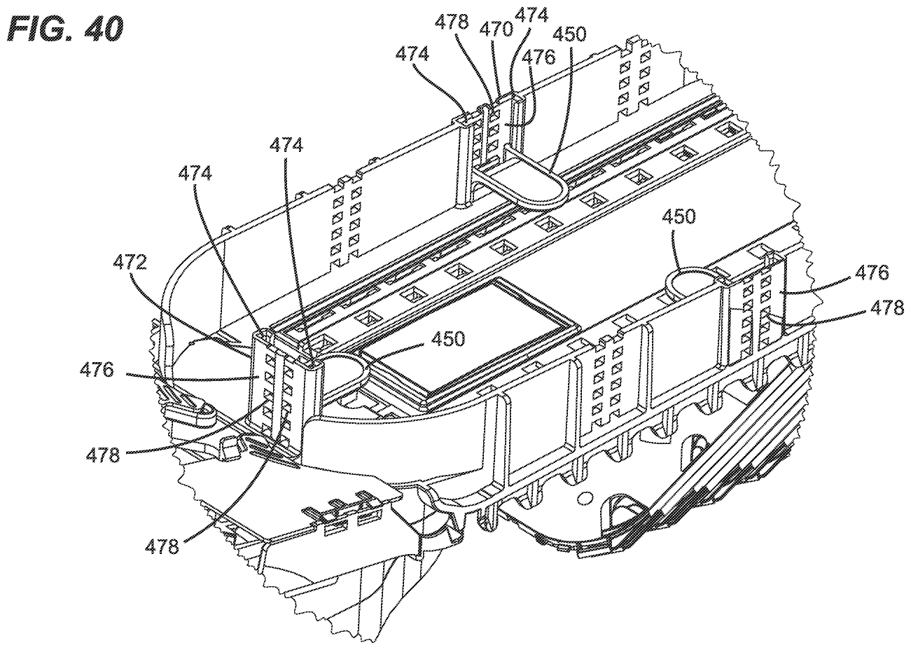

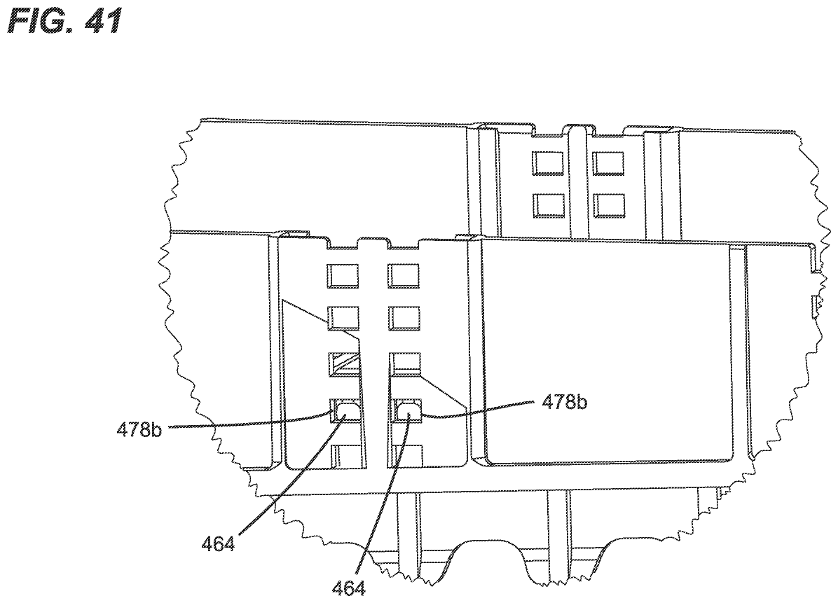

Referring to FIGS. 38 and 39, the retainers 450 are lockingly mounted at first mounting locations defined by first openings 478a in the receivers 470 and 472. Referring to FIGS. 40 and 41, the retainers 450 are lockingly mounted at second mounting locations defined by second openings 478b in the receivers 470 and 472. The first mounting locations are higher above the surface 414 (e.g., at a greater height relative to the basket's height dimension) than the second mounting locations. Thus, for example, greater numbers of fibers and/or lengths of fibers can be stored in the basket 412 with the retainers 450 positioned at the first locations than at the second locations. Accordingly, depending on a given use application, the height of the retainers 450 relative to the surface 414 of the basket 412 can be adjusted to accommodate the fibers that are to be stored in the basket 412 and to maximize their retention.

Though two mounting locations are shown for each retainer 450 in the depicted example, any number of mounting location heights can be accommodated by the retainer receivers, such as three, four, five or more mounting location heights.

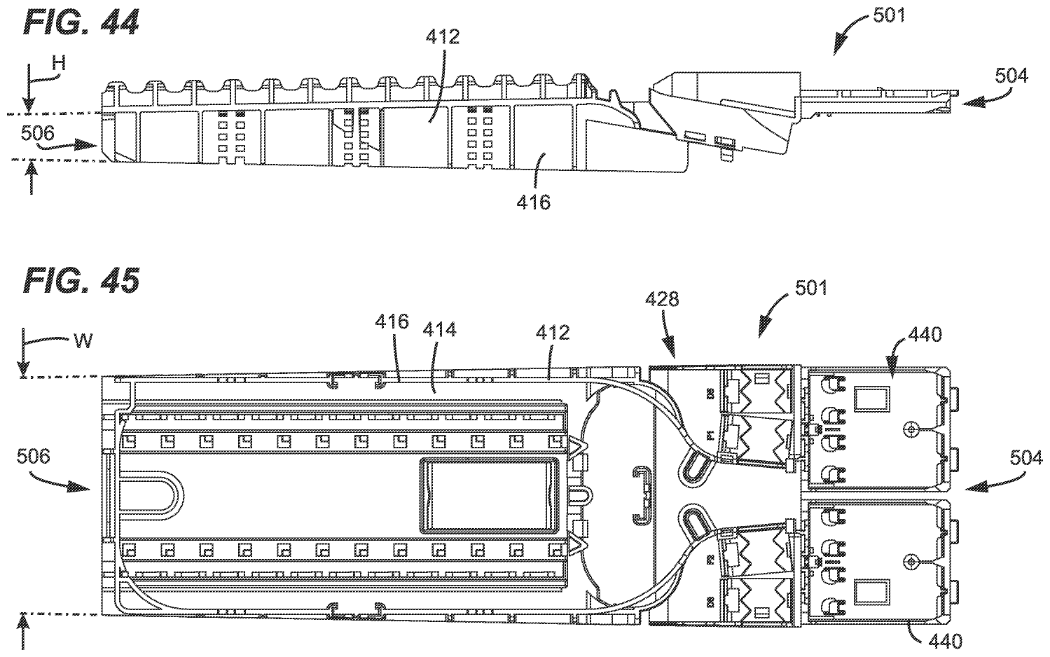

Referring to FIGS. 44-45, the unitarily integrated piece 501 of the assembly 400 is shown. The piece 501 includes the basket 412, the plates 440, and the fiber router 428.

As mentioned, the assembly 400 is configured to be inserted in the closure volume defined by the housing pieces of the closure 1000. As shown in FIG. 28, the housing piece 1200 is a dome that narrows or tapers as it extends away from the housing piece 1600 along the closure's longitudinal axis. As a result, the closure volume defined by the housing piece 1200 likewise tapers.

To maximize the usable space in the tapered closure volume of the closure 1000, the piece 501 likewise includes tapering features corresponding to the tapered dimension of the housing piece 1200.

For example, the piece 501 extends from a proximal end 504 to a distal end 506. The proximal end 504 corresponds to the end of the housing piece 1200 closest to the housing piece 1600, and the distal end 506 corresponds to the longitudinally opposing end of the housing piece 1200, when the piece 501 is positioned in the closure volume of the closure 1000 as part of the organizer 400.

The height dimension 422 decreases as the basket extends distally. That is, a height dimension H of the wall 416 relative to the surface 414 of the basket 412 decreases, tapering distally as it extends distally from the proximal end 504 of the piece 501. The tapering can be continuous along one or more portions of the longitudinal dimension of the basket, or along an entirety of the longitudinal dimension of the basket. This tapering defines a longitudinal tapering of the basket 412 and a longitudinal tapering of the piece 501 that results in a more efficient use of space defined by the housing piece 1200, when the piece 501 is positioned as part of an organizer 400 in the closure volume of the closure 1000.

In addition, the piece 501 tapers parallel to the axis 406 (FIG. 30) as the piece 501 extends distally away from the proximal end 504 towards the distal end 506. In particular, a width dimension W of the piece 501, which width dimension W is perpendicular to the height dimension H and parallel to the axis 406 decreases, tapering as the piece 501 extends distally away from the proximal end 504. This tapering defines a transverse tapering of the piece 501 that further results in a more efficient use of space defined by the housing piece 1200 when the piece 501 is positioned as part of an organizer 400 in the closure volume of the closure 1000. The tapering can be continuous along one or more portions of the longitudinal dimension of the basket, or along an entirety of the longitudinal dimension of the basket.

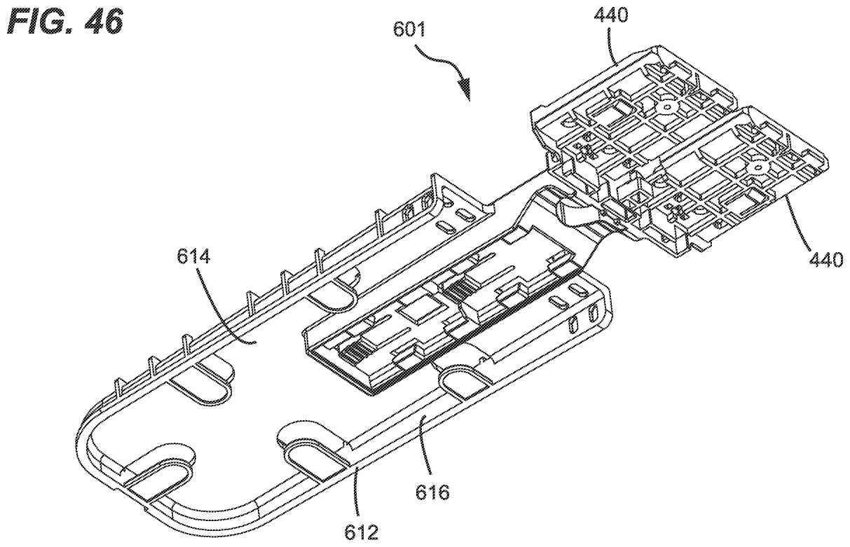

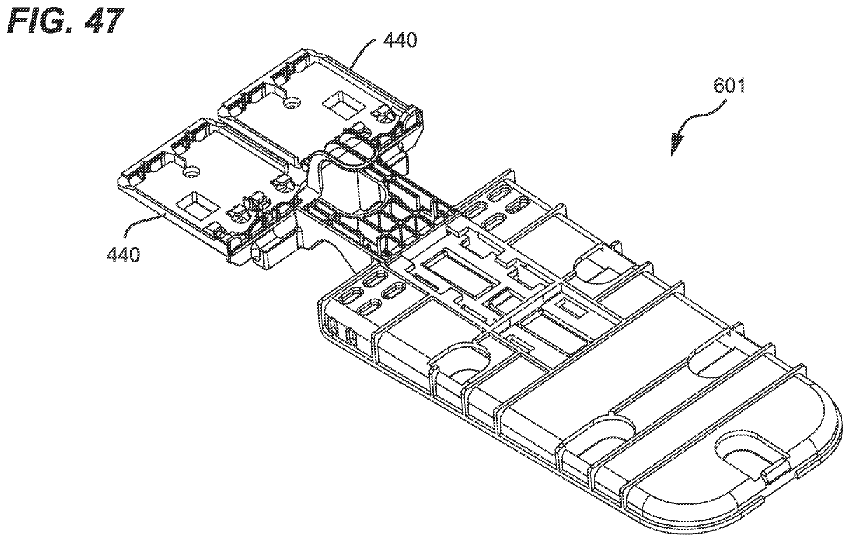

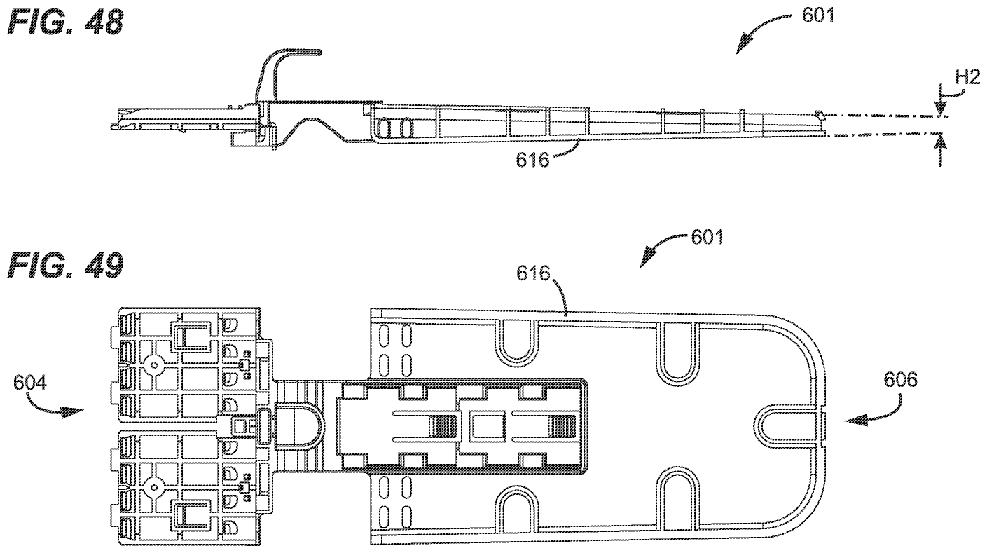

Referring to FIGS. 46-49, a unitarily constructed organizer piece 601 is shown. The organizer piece 601 is an alternative embodiment of the organizer piece 501 described above. The piece 601 includes the plates 440 and a basket 612, but does not include a fiber router 428. The basket volume defined by the basket 612 faces the opposite direction relative to the plates 440 as does the basket volume defined by the basket 412 of the piece 501.

The piece 601 extends from a proximal end 604 to a distal end 606. The proximal end 604 corresponds to the end of the housing piece 1200 closest to the housing piece 1600, and the distal end 606 corresponds to the longitudinally opposing end of the housing piece 1200, when the piece 601 is positioned in the closure volume of the closure 1000 as part of an organizer.

A height dimension H2 of the wall 616 of the basket 612 decreases relative to the surface 614 of the basket 612, tapering distally as it extends distally from the proximal end 604 towards the distal end 606. This tapering defines a longitudinal tapering of the basket 612 and a longitudinal tapering of the piece 601 that results in a more efficient use of space defined by the housing piece 1200, when the piece 601 is positioned as part of an organizer in the closure volume of the closure 1000.

In addition, the piece 601 tapers parallel to a transverse axis as the piece 601 extends distally away from the proximal end 604 towards the distal end 606. In particular, a width dimension W2 of the piece 601, which width dimension W2 is perpendicular to the height dimension H2 decreases, tapering as the piece 601 extends distally away from the proximal end 604. This tapering defines a transverse tapering of the piece 601 that further results in a more efficient use of space defined by the housing piece 1200, when the piece 601 is positioned in the closure volume of the closure 1000 as part of an organizer.

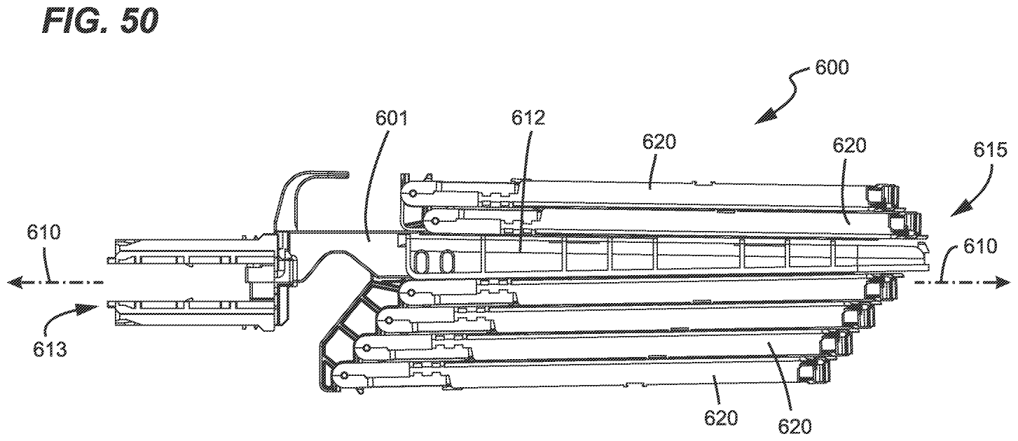

Referring to FIG. 50, an organizer 600 that includes the piece 601 is shown. The organizer 600 extends along a longitudinal axis 610 from a proximal end 613 of the organizer 600 to a distal end 615 of the organizer 600. The axis 610 is parallel to the longitudinal dimension of the piece 601 and parallel to the longitudinal dimension of the page in FIG. 50. As shown in FIG. 50, fiber management trays 620 are in stacked configurations on front and back sides of the piece 601. Due to the tapering of the piece 601 described above, the stacks of trays 620 (when pivoted toward the axis 610, as shown) also taper towards the axis 610 the farther away from the proximal end 613 the trays 620 are.

Thus, both the basket 612 and the stacks of trays 620 taper (e.g., continuously) as they extend distally away from the proximal end 613 toward the distal end 615 along the axis 610, which can result in a more efficient use of space defined by the housing piece 1200, when the piece 601 is positioned in the closure volume of the closure 1000 as part of an organizer.

The tapering of each stack of trays 620 relative to the axis 610 (or an angle formed between the stacking axis of each tray and the axis 610) can define a tapering angle that is greater than 0 degrees and less 10 degrees, or greater than 0 degrees and less than 5 degrees, or greater than 0 degrees and less than 3 degrees, depending on the corresponding taper of the housing piece of the closure in which the organizer 600 is intended to be housed.

From the foregoing detailed description, it will be evident that modifications and variations can be made in the devices of the disclosure without departing from the spirit or scope of the invention.

What is claimed is:

1. An optical fiber management organizer for a telecommunications closure, comprising:
a basket, including a support surface and walls extending from the support surface, the support surface and the walls defining a basket volume for storing loops of optical fibers;
a tray support structure, the tray support structure defining mounting locations for pivotally mounting optical fiber management trays; and
a fiber retainer, the fiber retainer including a retaining portion having a retaining body and a mounting portion having a mounting body, the mounting body being configured to lockingly engage the support structure at any of the mounting locations such that the retaining portion is positioned to retain the loops of optical fibers between a retaining surface of the retaining portion and the support surface of the basket.

2. The organizer of claim 1, where the basket includes fixed fiber retaining tabs extending from the walls.

3. The organizer of any of claims 1-2, wherein a maximum dimension of the retaining body along a longitudinal dimension of the fiber retainer is at least one fourth of a corresponding maximum dimension of the support surface along a longitudinal dimension of the basket.

4. The organizer of any of claims 1-3, wherein the tray support structure is configured for pivotally mounting the optical fiber management trays one atop another in a vertical stack of the trays.

5. The organizer of claim 4, wherein the fiber retainer is configured to slide horizontally into locking engagement with the tray support structure.

6. The organizer of claim 4, wherein the fiber retainer is configured to slide vertically into locking engagement with the tray support structure.

7. The organizer of any of claims 1-6, wherein the fiber retainer includes a socket coupling member configured to be received in a complementarily shaped and sized hinge pin socket defined by the tray support structure.

8. The organizer of any of claims 1-7, wherein the fiber retainer includes a resilient latch arm having a catch configured to engage the tray support structure to lock the fiber retainer to the tray support structure.

9. The organizer of claim 7, wherein the socket coupling member includes a rib having a taper, the taper being configured to wedge with the hinge pin socket when the fiber retainer is slid into engagement with the tray support structure.

10. The organizer of any of claims 1-7, wherein the mounting body includes a wedged rib configured to slidingly engage a groove defined by the tray support structure.

11. The organizer of claim 8, wherein the catch is configured to engage a shoulder of the tray support structure.

12. The organizer of claim 8, wherein the catch is configured to a engage a groove of the tray support structure.

13. The organizer of any of claims 1-12, wherein all of the mounting locations, including all mounting features that define the mounting locations, are of identical construction.

14. The organizer of any of claims 1-13, further comprising fiber management trays pivotally coupled to the tray support structure at at least two of the mounting locations, the fiber management trays including splice holders for holding protective bodies of splices between optical fibers.

15. The organizer of any of claims 1-14, wherein the tray support structure is lockingly engaged to the basket.

16. A fiber optic closure, comprising:
housing pieces configured to cooperate to define a sealable and re-enterable closure volume;
the organizer of any of claims 1-15 positioned within the closure volume; and
fiber optic cables entering the closure volume and fixed to the organizer, the cables including optical fibers that are routed to the basket and retained by the fiber retainer.

17. A fiber retainer, comprising:
a retaining portion having a retaining body and a mounting portion having a mounting body, the mounting body being configured to lockingly engage an optical fiber management tray support structure at any of a plurality of mounting locations defined by the support structure each of which is also configured to pivotally mount an optical fiber management tray.

18. The fiber retainer of claim 17,
wherein the tray support structure is configured for pivotally mounting the optical fiber management trays one atop another in a vertical stack of the trays; and
wherein the fiber retainer is configured to slide horizontally into locking engagement with the tray support structure.

19. The fiber retainer of claim 17,
wherein the tray support structure is configured for pivotally mounting the optical fiber management trays one atop another in a vertical stack of the trays; and
wherein the fiber retainer is configured to slide vertically into locking engagement with the tray support structure.

20. The fiber retainer of any of claims 17-19, wherein the fiber retainer includes a socket coupling member configured to be received in a complementarily shaped and sized hinge pin socket defined by the tray support structure.

21. The fiber retainer of any of claims 17-20, wherein the fiber retainer includes a resilient latch arm having a catch configured to engage the tray support structure to lock the fiber retainer to the tray support structure.

22. The fiber retainer of claim 20, wherein the socket coupling member includes a rib having a taper, the taper being configured to wedge with the hinge pin socket when the fiber retainer is slid into engagement with the tray support structure.

23. The fiber retainer of claim 20, wherein the mounting body includes a wedged rib configured to slidingly engage a groove defined by the tray support structure.

24. The fiber retainer of claim 21, wherein the catch is configured to engage a shoulder of the tray support structure.

25. A method of using a customizable fiber retainer to retain optical fibers positioned in a basket of an optical fiber organizer of a fiber optic closure, comprising:
a) arranging the optical fibers in the basket;
b) selecting one of a plurality of mounting locations on a tray support structure of the organizer, the tray support structure being configured to pivotally mount fiber management trays; and
c) subsequent to b) lockingly mounting the fiber retainer to the tray support structure at the selected mounting location.

26. The method of claim 25, wherein the mounting location is selected based on a number of fiber management trays mounted to and/or to be mounted to the tray support structure.

27. The method of any of claims 25-26, wherein the mounting location is selected based on a quantity or volume of the fibers positioned in the tray.

28. The method of any of claims 25-27, further comprising:
d) subsequent to c), removing the fiber retainer from the mounting location.

29. The method of claim 28, further comprising:
e) subsequent to d), mounting the fiber retainer to the tray support structure at a different one of the mounting locations.

30. The method of any of claims 25-29,
wherein the support structure is configured to pivotally mount fiber management trays one atop another in a vertical stack of the trays; and
wherein b) includes sliding the fiber retainer horizontally into locking engagement with the support structure.

31. The method of any of claims 25-29,
wherein the support structure is configured to pivotally mount fiber management trays one atop another in a vertical stack of the trays; and
wherein b) includes sliding the fiber retainer vertically into locking engagement with the support structure.

32. An optical fiber management organizer for a telecommunications closure, comprising:
a basket, including a support surface and a wall extending from the support surface, the support surface and the wall defining a basket volume for storing loops of optical fibers, a dimension of the wall perpendicular to the support surface defining a height dimension of the basket volume; and
a fiber retainer, the fiber retainer including a retaining portion having a retaining body and a mounting portion having a mounting body, the mounting body being configured to be locked at each of a plurality of mounting locations, each of the mounting locations being at a different height relative to the height dimension of the basket volume.

33. The organizer of claim 32, wherein the mounting locations are defined by the wall of the basket.

34. The organizer of claim 32, wherein the mounting locations are defined by a fiber management tray support structure of the organizer.

35. The organizer of claim 33,
wherein the wall defines a fully enclosed opening at each of the mounting locations;
wherein the mounting body includes a flexibly resilient arm having a catch; and
wherein the catch is configured to be received in the fully enclosed opening to set a height of the fiber retainer relative to the height of the basket volume.

36. The organizer of claim 35,
wherein the wall defines guides that are elongate parallel to the height dimension; and
wherein the fiber retainer includes tabs configured to slide within the guides parallel to the height dimension to adjust a height of the fiber retainer.

37. A fiber optic closure, comprising:
housing pieces configured to cooperate to define a sealable and re-enterable closure volume;
the organizer of any of claims 32-36 positioned within the closure volume; and
fiber optic cables entering the closure volume and fixed to the organizer, the cables including optical fibers that are routed to the basket and retained by the fiber retainer within the basket volume.

38. A method of using a customizable fiber retainer to retain optical fibers positioned in a basket of an optical fiber organizer of a fiber optic closure, the basket including a support surface and a wall extending from the support surface, the support surface and the wall defining a basket volume, a dimension of the wall perpendicular to the support surface defining a height dimension of the basket volume, the method comprising:
a) arranging the optical fibers in the basket;
b) selecting one of a plurality of mounting locations to provide a selected mounting location, each of the mounting locations being at a different height along the height dimension of the basket volume; and
c) subsequent to b) lockingly mounting the fiber retainer at the selected mounting location.

39. The method of claim 38, wherein a) is performed before b).

40. The method of any of claims 38-39, wherein b) is performed before a).

41. The method of any of claims 38-40, wherein the mounting locations are defined by the wall of the basket.

42. The method of any of claims 38-41, wherein the mounting location is selected based on a quantity or a volume of the fibers positioned in the tray.

43. The method of any of claims 38-42, further comprising:
unlocking the fiber retainer from the selected mounting location; and
sliding the fiber retainer within a guide of the basket until the fiber retainer lockingly mounts to another of the plurality of mounting locations.

44. The organizer of claim 32, wherein the mounting locations are defined by a fiber retainer receiver of the basket.

45. The method of claim 25, wherein a) is performed before b).

46. The method of claim 25, wherein b) is performed before a).

47. The organizer of any of claims 32-36, wherein the height dimension decreases along a longitudinal dimension of the basket.

48. An optical fiber management organizer for a telecommunications closure, comprising:
a basket, including a support surface and a wall extending from the support surface, the support surface and the wall defining a basket volume for storing loops of optical fibers, a dimension of the wall perpendicular to the support surface defining a height dimension of the basket volume,
wherein the height dimension decreases continuously along at least a portion of a longitudinal dimension of the basket.

49. The organizer of claim 48,
wherein the support surface has a width dimension perpendicular to the height dimension; and
wherein the width dimension decreases continuously along at least a portion of the longitudinal dimension of the basket.

50. The organizer of claim 48, further comprising a stack of pivotally mounted fiber management trays that tapers towards a longitudinal axis defined by the organizer.

51. The organizer of claim 50, further comprising another stack of pivotally mounted fiber management trays on an opposite side of the organizer as the stack, the another stack tapering towards the longitudinal axis defined by the organizer.

52. An optical fiber management organizer for a telecommunications closure, comprising:
a piece; and
a stack of fiber management trays pivotally mounted relative to the piece and that tapers towards a longitudinal axis defined by the organizer.

53. The organizer of claim 52, further comprising another stack of pivotally mounted fiber management trays on an opposite side of the organizer as the stack, the another stack tapering towards the longitudinal axis defined by the organizer.

54. The organizer of any of claims 52-53, further comprising one or more of:
a basket for storing loops of optical fibers;
optical fiber routing structures;
optical fiber sheath holders; and
plates for supporting cable fixation bases.

55. A fiber optic closure, comprising:
housing pieces configured to cooperate to define a sealable and re-enterable closure volume;
the organizer of any of claims 47-54 positioned within the closure volume; and
fiber optic cables entering the closure volume and fixed to the organizer.

56. The fiber retainer of claim 21, wherein the catch is configured to engage a groove of the tray support structure.
